(19) United States
(12) Patent Application Publication
(10) Pub. No.: US 2024/0009630 A1
(43) Pub. Date: Jan. 11, 2024

(54) POROUS AND MONOLITHIC CARBON MEMBRANES AND THEIR USE

(71) Applicant: The University of Chicago, Chicago, IL (US)

(72) Inventors: Bozhi Tian, Chicago, IL (US); Aleksander Prominski, Chicago, IL (US); Lingyuan Meng, Chicago, IL (US)

(21) Appl. No.: 18/254,301

(22) PCT Filed: Nov. 30, 2021
(86) PCT No.: PCT/US2021/061122

§ 371 Date: May 24, 2023

Related U.S. Application Data
(60) Provisional application No. 63/119,612, filed on Nov. 30, 2020.

(51) Int. Cl. B01D 67/00; B01D 69/02; B01D 69/12; B01D 71/02

(52) U.S. Cl. CPC B01D 67/0058; B01D 69/02; B01D 69/12; B01D 71/021; B01D 2325/0283

(57) ABSTRACT

This disclosure relates to methods for modulating activity of cells and tissue with materials that are capable of being activated by an energy pulse, such methods useful for treating diseases. The disclosure also provides devices and systems suitable for use in such methods, particularly devices and systems having a carbon-based material comprising one or more monolithic porous carbon membranes.

### CROSS-REFERENCE TO RELATED APPLICATIONS

This application is a 371 U.S. national phase of PCT/US2021/061122, filed Nov. 30, 2021, which claims the benefit of priority of U.S. Provisional Patent Application No. 63/119,612, filed Nov. 30, 2020, which applications are incorporated herein by reference in their entirety.

### STATEMENT REGARDING FEDERALLY SPONSORED RESEARCH OR DEVELOPMENT

This invention was made with government support under grant number NS101488 awarded by The National Institutes of Health, and grant number W911NF-18-1-0042 awarded by Army Research Office, and 1848613 awarded by The National Science Foundation, and grant numbers N00014-16-1-2530 and N00014-16-1-2958 awarded by Office of Naval Research. The government has certain rights in this invention.

### BACKGROUND OF THE DISCLOSURE

Modern bioelectronics with multi-scale structures are used extensively for drug delivery, biosensing, and biological modulations. Through modulation of biological activities, these bioelectronics have contributed to our improved understanding of biological dynamics and function. Moreover, they hold great therapeutic potential for treating many biological disorders, including Parkinson's disease, congenital heart defects, and paralysis. Macroscopic bioelectronic devices, however, are usually rigid and mechanically invasive to cells and tissues. Their large feature sizes also make subcellular biointerfaces difficult to form. Many devices also display faradaic reactions at the electrode surfaces, which can generate toxic reactive species, corrode electrodes, and cause permanent damage to adjacent tissues.

Nanostructuring of the bioelectronics surfaces represents a promising way to improve the device performance. Standard bioelectronic stimulation materials, such as platinum, iridium oxide, or titanium nitride, all display enhanced charge injection limits when their surfaces become nanostructured or porous. Nanostructured conducting polymer-based bioelectronics, such as those based on poly(3,4-ethylenedioxythiophene) polystyrene sulfonate (PEDOT:PSS), are also widely used for biological interfaces, and they show great electronic/ionic conductivity, internal porosity and volumetric capacitance, and excellent mechanical properties8. Improvements are ongoing to make these polymer electrodes electrochemically more stable, especially in terms of repeated operation and swelling during long-term soaking in saline solution. Besides, electrode surface coating with carbon nanomaterials, such as graphene and carbon nanotubes (CNTs), are widely used to reduce the impedance at the electrode/saline junctions and increase the charge transfer rate. The polymer binding process usually associated with carbon coating procedures, however, may result in ‘dead’ volumes or surfaces and increased total device thickness. Moreover, the potential production of freestanding carbon nanostructures after dissociation of the coating layer may result in biological complications in vivo. Carbon nanostructures have nevertheless been advancing modern electronics in multiple areas, such as supercapacitor or micro-supercapacitor-based power elements, as well as stretchable or bendable microelectrodes for biointerfaces.

Even so, there still exists a need to further advance carbon-based materials toward cheap, stable, minimally invasive, high performance and multifunctional bioelectronic devices.

### SUMMARY OF THE DISCLOSURE

The inventors have used micelle-enabled self-assembly to prepare a binder-free (i.e., monolithic), carbon-based, and flexible micro-supercapacitor-like systems. The inventors have found that such carbon-based systems have many key features, such as surface and internal porosity, mechanical compliance, and the use of nanomaterial building blocks for bottom-up construction, suitable for use in various types of bioelectronic interfaces.

Thus, one aspect of the disclosure provides devices that comprise binder-free (i.e., monolithic) porous carbon membranes. Specifically, the device of the disclosure is a carbon-based material comprising one or more monolithic porous carbon membranes, and a flexible substrate comprising one or more of polymers in which the material is distributed.

Another aspect of the disclosure methods for modulating activity of a cell capable of being activated by an energy pulse, such as an electrochemical energy pulse. Such methods include contacting a membrane of the cell with a device of the disclosure as described herein to form a structure-cell membrane interface; providing an energy pulse the interface under conditions to depolarize the cell membrane thereby increase a threshold for activation of the cell.

Another aspect of the disclosure provides methods of treating a disease in a subject by modulating activation of a cell. Such methods include (i) providing one or more devices of the disclosure as described herein (including a carbon-based material) to the affected cell(s) in the subject; and (ii) providing an energy pulse (e.g., an electrochemical energy pulse) to the device under conditions sufficient to overcome (such as, e.g., increase) a threshold for activation of the cell(s) and treat the disease.

In certain embodiments, the methods of the disclosure treat a neuronal disease. In certain embodiments, the methods of the disclosure treat an ophthalmic disease.

In certain other embodiments, the methods of the disclosure treat a cardiovascular disease. For example, in certain aspects of the disclosure, methods of the disclosure electrochemically train myocardium to beat at a target frequency.

Thus, one aspect of the disclosure provides a method for electrochemically training myocardium to beat at a target frequency. This method includes (i) contacting the myocardium with one or more devices of the disclosure as described herein (including a carbon-based material); and (ii) operating a pulse generator source to provide, during a training period of time, a plurality of energy pulses (such as electrochemical energy pulses) to the myocardium at the target frequency.

The disclosure also provides systems suitable for use in the methods of the disclosure. Thus, in one aspect, the disclosure provides a system for treating a disease in a subject by modulating activation of a cell. Such system includes: (i) one or more devices of the disclosure as described herein or one or more carbon-based materials of the disclosure as described herein; (ii) a pulse generator source configured to provide an energy pulse (e.g., an electrochemical energy pulse) to the device, wherein the one or more devices provide, to the cell they are in contact with, excitatory stimulus in response to receiving the energy pulse; and (iii) a controller that is operably coupled to the pulse generator source, wherein the controller comprises one or more processors, wherein the controller is programmed to perform controller operations including: operating the pulse generator source to provide the energy pulse to the cell.

In certain embodiments of this aspect, the disclosure provides a system for electrochemically training myocardium to beat at a target frequency. As provided herein, such system includes: (i) one or more devices of the disclosure as described herein or one or more carbon-based materials of the disclosure as described herein; (ii) a pulse generator source configured to provide an energy pulse (e.g., an electrochemical energy pulse) to the device, wherein the one or more devices provide, to the cell they are in contact with, excitatory stimulus in response to receiving the energy pulse; and (iii) a controller that is operably coupled to the pulse generator source, wherein the controller comprises one or more processors, wherein the controller is programmed to perform controller operations including: operating the pulse generator source to provide the energy pulse to the cell.

Other objects, features and advantages of the present disclosure will become apparent from the following detailed description. It should be understood, however, that the detailed description and the specific examples, while indicating specific embodiments of the disclosure, are given by way of illustration only, since various changes and modifications within the spirit and scope of the invention will become apparent to those skilled in the art from this detailed description.

### BRIEF DESCRIPTION OF THE DRAWINGS

The accompanying drawings are included to provide a further understanding of the systems and methods of the disclosure, and are incorporated in and constitute a part of this specification. The drawings are not necessarily to scale, and sizes of various elements may be distorted for clarity. The drawings illustrate one or more embodiment(s) of the disclosure and, together with the description, serve to explain the principles and operation of the disclosure.

FIG. 1 shows hierarchical porous carbon synthesis and characterization. (a) Illustration of the preparation of hierarchical porous carbon. (i) Synthesis of mesoporous carbon; (ii) synthesis of hierarchical carbon containing both mesopores and macropores; (iii) layer-by-layer assembly of carbon layers creating porosity gradient. The bottom layer of the carbon membranes will become the side for biointerface formation after the device fabrication is completed (FIG. 2a, and FIG. 6). (b) Transmission electron microscopy (TEM; left; scale bar, 100 nm), corresponding fast Fourier transform (FFT) diffraction pattern (left inset) and scanning electron microscopy (SEM) images (right; scale bar, 100 nm) of mesoporous materials showing the highly ordered mesostructures. (c) Cross-sectional view (upper panels) and associated top view (lower panels) of the hierarchical porous material. The hierarchical structures display two components: a bottom layer constructed from ordered mesoporous structure and layers of porous vesicles assembled into multiple layers. Scale bar, 200 nm. (d) Left: load versus displacement plots of the hierarchical porous thin film measured with a nano-indenter with various numbers of vesicle layers. Right: Hardness and Young's modulus calculated from the load versus displacement plots. As the number of layers increases, the Young's modulus and hardness decrease, indicating that the film becomes softer. (e) Cross-sectional (false color) SEM image of cardiomyocytes (CMs) cultured on the hierarchical porous film, implying that soft-hard hybrid interfaces can form between the film and cells. Scale bar, 500 nm.

FIG. 2 shows device fabrication and characterization. (a) Overview of a flexible device fabrication workflow. (b) An optical image (left; scale bar, 1 mm) and a close-up view of the hierarchical porous carbon micro-supercapacitor device (right; scale bar, 200 μm). (c) Raman spectra for the micro-supercapacitor device at the indicated locations (left: scale bar, 10 μm). The spectra showing typical carbon peaks at around 1330 cm⁻¹ and 1590 cm⁻¹ are only found in the designed pattern region (right). (d) CV profiles for the micro-supercapacitor at different scan rates in cell culture medium DMEM. (e) Charge-discharge curves in DMEM medium of the micro-supercapacitor device at different current densities for the time window of 6 s (top) and 10 s (bottom). (f) Electrochemical stability of the device during storage at 37° C. in a buffer solution (PBS) over a 1-month period. (g) Electrochemical stability over 1,000,000 CV cycles in the range −0.1 to 0.1 V at the frequency of 4 Hz at 37° C. in a buffer solution (PBS).

FIG. 3 shows in vitro biological training. (a) Immunohistochemistry images for cardiac cells cultured on the micro-supercapacitor device. Cells were stained for cardiac troponin (CMs, green), connexin-43 (magenta), vimentin (fibroblasts, red) and DAPI (nucleus, blue). The dash lines show the edge of the interdigitated carbon electrodes. Scale bar, 10 μm. (b) Upper left: representative image of CMs loaded with calcium sensitive dye; transmitted light shows the micro-supercapacitor (appeared in black). Scale bar, 10 μm. Upper right: device voltage (top) and input current density (bottom) during the stimulation. Bottom: cell contraction rate illustrated by plotting the intensity profile of the region of interest (ROI, highlighted in the image). (c) Representative image of CMs loaded with calcium sensitive dye recorded during subthreshold stimulation for 2000 s. Scale bar, 10 μm. Overlay shows approximate positions of CMs in the field of view and their cluster assignment was color-coded in blue (cluster 1) and red (cluster 2). (d) Representative traces of fluorescence intensities at the region of interest (ROI dots in panel c) at the beginning of experiment and at 1100, 1500 and 1900 s of stimulation. (e) Frequency analysis of cell contraction frequency during subthreshold training. Top panel shows the voltage (left) and the input current density (right) waveforms during the training process. Bottom: frequency analysis shows fluctuating but gradual increase in the contraction rate, which eventually reached the target training frequency of 1 Hz.

FIG. 4 shows biological modulation at the tissue and organ level. (a) Left: schematic of the experimental setup for the retinal stimulation. Right: a max-intensity projection of RGCs expressing GCaMP6. Scale bar, 25 μm. (b) Top: a retinal calcium image showing activated RGCs upon the stimulation. Scale bar, 15 μm. Middle: representative calcium traces from individual RGCs (numbered in the upper image). Bottom: the input current density during the stimulation. (c) Top: calcium transient traces represented as average±standard error in both control and glutamate antagonist conditions. Bottom: the quantification of response amplitudes of calcium transients. (d) Schematic of the Langendorff perfusion system. Heart perfusion pressure was constantly monitored and kept stable using gravity perfusion. ECG and LVP were monitored to show the effect of stimulation on the heart rate. (e) Images of a micro-supercapacitor-like device conforming around a cylindrical holder (left; scale bar, 2 mm) and around the curvilinear and contractile cardiac tissue (upper right; scale bar, 5 mm) with a close-up view (lower right; scale bar, 500 μm). (f) Representative LVP profiles and ECG recordings of the isolated heart stimulated at a frequency of 1 Hz. Input current density was synchronized to the corresponding stimulated portions of the LVP and ECG recordings. Dashed boxes and arrows are spontaneous APs (black) and APs that follow positive (green) and negative (pink) artifacts. (g) A closer look of the APs in the ECG recording with corresponding colors (spontaneous, black; positive, green; and negative, pink). (h) Representative LVP and ECG profiles of the isolated heart stimulated by 2 Hz square current waveform (left), 5 ms alternating pulses (middle), 1 ms biphasic pulses (right) to achieve pacing at 4 Hz.

FIG. 5 shows the mesoporous carbon has narrow pore size distribution. Nitrogen adsorption and desorption curves of a mesoporous carbon film with corresponding pore size distribution (inset).

FIG. 6 shows the device fabrication and design are scalable and generalizable. (a) Cross-sectional schematics of the flexible micro-supercapacitor device fabrication. (b) Geometry of a representative interdigitated electrode pattern used in the flexible devices. (c) CAD design of the large area device. (d) CAD design of 8-site multichannel recording/stimulation device. Interconnects and FFC header not shown. Dashed rectangles in (c) and (d) show sample position of features displayed in (b). All measurements are in millimeters.

FIG. 7 shows COMSOL simulation of electric potentials suggests that the interdigitated design has more confined electric potential distribution. (a) 2D geometry of a 2-prong large electrode device. (b) 2D geometry of a 10-prong electrode device. (c) Simulated electrolyte potentials in the gap between the two electrodes with a relative voltage of 1 V. Comparison of the cross-sectional electric potential distributions between a ten-prong micro-supercapacitor and a two-electrode system of same area show differences in the electric potential penetration depth.

FIG. 8 shows device impedance characterization suggests good interfacial charge transport. Impedance measurements of the micro-supercapacitor device in DMEM culture medium (black) and PBS (red).

FIG. 9 shows LDH assays suggest reasonable in vitro biocompatibility. LDH cytotoxicity percentage from the fibroblasts seeded on SU-8 and carbon devices. Treatment with 10 μg/mL cycloheximide (CHX) for 24 hours was used to induce cell death as a positive control for this assay. LDH cytotoxicity percentage from the fibroblasts on carbon micro-supercapacitor was around 8.77% on day 1 (D1) and 4.93% on day 2 (D2) in comparison to 3.91% on D1 and 2.97% on D2 in the SU-8 groups. N=5. *P<0.05, ****P<0.0001, and n. s. for P>0.05 by unpaired two-tailed t tests.

FIG. 10 shows histology results of mice tissues near the implanted devices suggest reasonable in vivo biocompatibility Body weights measured at 4 time points upon implantation. Compared to the control group (with pseudo implantation) and the group with SU-8 implantations. no statistically significant weight loss was observed after implantations of carbon-based micro-supercapacitor-like devices in all measured time points. N=15 for week 0 SU-8 and week 0 carbon; N=5 for all other groups. Unpaired two-tailed t-tests were performed, comparing the carbon group versus the control group and the carbon group versus the SU-8 group and no significant difference (P>0.05) was shown in all comparisons in 4 measure time points.

FIG. 11 shows the porous carbon-based devices can be used for in vivo nerve stimulation. (a) Schematic illustrating the in vivo experimental setup. (b-d) The representative EMG recording of the stimulated limb (top) and the corresponding input current (bottom).

FIG. 12 shows the porous carbon-based devices can be used for ECG recording of rat heart electrophysiology. (a) Recording using large area carbon electrode as a positive lead. Recording using large area carbon electrodes as positive and negative leads. (c) Photograph of multielectrode array positioned on rat heart (recording site approximately 4 mm²) and (d-g) recording from specific sites. Traces (i-iv) were recorded under at different time points, but without moving the electrode. In these studies, we showed that the porous carbon device can be used for bioelectrical recording. In the isolated heart model, we assembled ECG recording leads with positive lead at LV, negative at the aorta and ground at the cannula. We found that micro-supercapacitor-like device can successfully be used as a positive (a) or positive and negative leads (b) for ECG recording. Additionally, we fabricated multichannel electrodes with reduced area per single recording site (4 mm² vs 40 mm² for large area device) (c), and demonstrated the recording from the individual site.

### DETAILED DESCRIPTION

Before the disclosed methods and materials are described, it is to be understood that the aspects described herein are not limited to specific embodiments, and as such can, of course, vary. It is also to be understood that the terminology used herein is for the purpose of describing particular aspects only and, unless specifically defined herein, is not intended to be limiting.

In view of the present disclosure, the methods and systems described herein can be configured by the person of ordinary skill in the art to meet the desired need. As provided above, inventors used micelle-enabled self-assembly to prepare a binder-free (i.e., monolithic), carbon-based, and flexible micro-supercapacitor-like systems. The inventors have found that such carbon-based systems have many key features, such as surface and internal porosity, mechanical compliance, and the use of nanomaterial building blocks for bottom-up construction, suitable for use in various types of bioelectronic interfaces. For example, the monolithic carbon minimized the biocompatibility complication associated with freestanding carbon nanostructures, while the interdigitated electrode design shrunk the feature size of the otherwise bulky electrode for subcellular interfaces.

As provided above, one aspect of the disclosure provides devices that comprise binder-free (i.e., monolithic) porous carbon membranes. Specifically, the device of the disclosure is a carbon-based material comprising one or more monolithic porous carbon membranes, and a flexible substrate comprising one or more of polymers in which the material is distributed.

In certain embodiments of the devices of the disclosure, the carbon membranes may have uniform pore size. Thus, in certain embodiments, the distribution of the average diameters of the pore sizes follows a Gaussian profile.

For example, in certain embodiments of the devices of the disclosure, the carbon membranes may have a relatively narrow pore size distribution. As the person of ordinary skill in the art will appreciate, the pore size distribution can be characterized by d50, d10 and d90 values, where d50 is the median pore size, d10 is the pore size at the 10^{th} percentile of pores ranked by size, and d90 is the pore size at the 90^{th} percentile of pores ranked by size. In certain embodiments, the pores sizes of at least one carbon membrane as otherwise described herein have a d50 value in the range of 2 nm to 30 nm, e.g., in the range of 2 nm to 10 nm. In certain embodiments, d10 is no less than 50% of d50 and d90 is no more than 150% of d50. In certain other embodiments, d10 is no less than 60% of d50 and d90 is no more than 140% of d50. In certain embodiments, d10 is no less than 70% of d50 and d90 is no more than 130% of d50. In certain other embodiments, d10 is no less than 75% of d50 and d90 is no more than 125% of d50. In certain embodiments of the disclosure, d10 is no less than 80% of d50 and d90 is no more than 120% of d50. In certain other embodiments of the disclosure, d10 is no less than 90% of d50 and d90 is no more than 110% of d50.

In certain embodiments, the carbon-based material of the disclosure as described herein comprises at least one carbon membrane that is macroporous (e.g., having a pore size of >50 nm). For example, in certain embodiments, the carbon-based material has a pore size in the range of 60 nm and 2000 nm, or in the range of 100 nm and 1000 nm, or in the range of 200 nm and 2000 nm.

In certain embodiments, the carbon-based material of the disclosure as described herein comprises at least one carbon membrane comprising mesopores and macropores. For example, in certain embodiments, at least one carbon membrane has a pore size in the range of 2 nm and 30 nm and in the range of 60 nm and 2000 nm.

The carbon-based material of the disclosure as described herein, in certain embodiments, comprises two or more monolithic porous carbon membranes. These different the carbon membranes may have different porosity. For example, the carbon-based material has a gradient porosity. In certain embodiments, at least one carbon membrane is mesoporous. In certain embodiments, at least one carbon membrane is macroporous. In certain embodiments, at least one carbon membrane comprises mesopores and macropores.

The carbon membrane of the disclosure may be distributed in a flexible substrate. Distributed carbon membrane may be partially embedded or on the surface (e.g., bound to the surface) of the flexible substrate. In certain embodiments, partially embedded includes 10%, or 20%, or 30%, or 40%, or 50%, or 60%, or 70%, or even 80% of the total weight of carbon membrane is embedded into the flexible substrate.

Many suitable flexible substrates are known in the art. As provided above, in certain embodiments of the disclosure, the flexible substrate is a polymer. In some embodiments, the polymer is selected from a photoresist polymer, a biocompatible polymer, a biodegradable polymer, an extracellular matrix protein, and a combination thereof. In some embodiments, the polymer is SU-8 photoresist. In some embodiments, the polymer is polydimethylsiloxane, poly(methyl methacrylate), poly lactic-co-glycolic acid, poly(ethylene glycol) diacrylate, collagen, or gelatin.

In certain embodiments, the flexible substrate has an open porosity of at least about 10%. For example, the flexible substrate has an open porosity of at least about 30%, or 40%, or 45%, or 50%, or 55%, or even 60%. In certain embodiments, the flexible substrate is non-porous.

The monolithic porous carbon membranes of the disclosure may be prepared by a process comprising:
contacting a carbon precursor with an organic template in a carrier solution to form a dispersion of micelles within the carrier solution;
providing the carrier solution with the dispersion of micelles to a silicon oxide substrate;
removing the carrier solution and heating the substrate to obtain the monolithic porous carbon membrane.

In certain embodiments, the process of the disclosure further comprises:
contacting the second planar surface of the monolithic porous carbon membrane with a first planar surface of a metal layer having a first planar surface and a second planar surface; and
optionally providing a flexible substrate to the second planar surface of the metal layer.

The inventors have also found that the devices can operate under either micro-supercapacitor-like or a traditional monopolar electrode configuration under physiological conditions. For example, the inventors have also found that the devices modulated cardiomyocytes (CMs) in vitro, excited of isolated heart and retinal tissues ex vivo, and stimulated of sciatic nerves in vivo. The device were also capable of bioelectronic cardiac recording.

Another aspect of the disclosure methods for modulating activity of a cell capable of being activated by an energy pulse. For example, the activity of the cell can be modulated by the ion fluxes that are controlled by an electrochemical energy pulse provided by the super-capacitor-like devices. Such methods include contacting a membrane of the cell with a device of the disclosure as described herein to form a structure-cell membrane interface; providing an energy pulse the interface under conditions to depolarize the cell membrane thereby increase a threshold for activation of the cell.

The depolarization of the cell membrane thereby increases a threshold for activation of the cell. The amount of energy needs to be sufficient to accomplish polarization, yet low enough to not harm the cell. Thus, suitable exposing time and power of the pulse will be selected so to provide the desired activity without the toxicity to the cell. In the methods and systems of the disclosure as described herein, the energy pulse may have a frequency ranging from 0.25 Hz to 50 Hz. For example, in certain embodiments, the frequency may be in a range of 0.5 to 3 Hz, or in the range of 0.5 to 10 Hz, or in the range of 10 to 50 Hz.

In certain embodiments, a single pulse is sufficient to modulate activity of a cell. In certain embodiments, two or more pulses are sufficient to modulate activity of a cell. In certain embodiments, 5 or more, or 10 or more, or 25 or more, or 50 or more pulses are sufficient to modulate activity of a cell. In certain embodiments, 1 to 5, or 1 to 10, or 1 to 25, or 1 to 50, or 1 to 100, or 2 to 5, or 2 to 10, or 2 to 25, or 2 to 50, or 2 to 100, or 5 to 10, or 5 to 25, or 5 to 50, or 5 to 100 pulses are sufficient to modulate activity of a cell.

In certain embodiments, the structure-cell interface is a direct interface between the device and the cell membrane (i.e., there are no intervening structures between the carbon device and the cell membrane). In certain embodiments of the methods of the disclosure, the carbon device contacts the membrane without penetrating the membrane. For example, the carbon device may rest on the surface of the cell membrane.

Any cell capable of being activated by an energy pulse may be used in the methods of the disclosure. In some embodiments, the cell is a cardiomyocyte, a neuron, or a retinal cell. In some embodiments, the cell is a cardiomyocyte or a neuron. In certain embodiments, the cell is a cardiomyocyte. In certain embodiments, the cell is a neuron. In certain embodiments, the cell is retinal cell.

Another aspect of the disclosure provides methods of treating a disease in a subject by modulating activation of a cell. In certain embodiments of the disclosure, the method is treating a neuronal disease. In certain embodiments, the method is treating an ophthalmic disease. In certain other embodiments, the methods of the disclosure treat a cardiovascular disease. For example, in certain aspects of the disclosure, methods of the disclosure electrochemically train myocardium to beat at a target frequency.

In certain embodiments, the methods of the disclosure treat a disease associated with sciatic nerve. For example, such disease includes, but is not limited to, pain, spinal cord injuries, osteoporosis, urinary and/or bowel incontinence.

The method of the disclosure may be useful as cardiac resynchronization therapy (CRT). In such method, the myocardium is contacted with two or more devices of the disclosure as described herein.

It can be beneficial in a variety of applications to apply the devices (or carbon-based materials) as described herein to the stimulation and control of the activity of myocardium (e.g., myocardium of a heart of a person or animal). These devices can be used to efficiently control the pacing of a heart and/or to correct some other deleterious electrical and/or pacing condition of the heart (e.g., bradycardia, tachycardia, ventrical or atrial fibrillation). These devices may additionally or alternatively be used to “retrain” the electrical behavior of the myocardium of the heart, e.g., to train the heart tissue to beat at a more appropriate target rate, to change a pattern of electrical connection or conduction of the heart, or to train the myocardium of the heart in some other manner. The use of the devices of the disclosure may provide a variety of benefits relative to the use of electrodes to pace or otherwise manipulate the heart, e.g., by providing a more energy-efficient interface that has a mechanical compliance that is better matched to the heart tissue.

In order to use the devices described herein to facilitate electrochemical manipulation of the electrical and/or physiological properties of myocardium, in the devices of the disclosure carbon-based materials of the disclosure distributed on or within a substrate (e.g., a substrate formed from a polymer). In certain embodiments, the substrate is a flexible substrate. The flexible substrate material can provide a base for the carbon-based materials of the disclosure, facilitating their organization and implantation within a body (e.g., by contacting with a surface of a heart or some other surface of a myocardial tissue) such that, when the devices receive energy pulses, nearby cardiac cells receive electrical or other stimulus. The substrate, in certain embodiments, can also be a hard, inflexible substrate. One of skill in the art would be able to select suitable inflexible materials that can provide a base for the device.

In certain embodiments, the membrane is configured to be placed in contact with cells of the myocardium such that the one or more devices are in contact with cells of the myocardium. In certain embodiments, such methods further comprise detecting a pulse rate of the myocardium during a detection period of time, wherein the detection period of time differs from the training period of time. For example, in certain embodiments, the detection period of time is subsequent to the training period of time, and the method further comprises: responsive to the detected pulse rate differing from the target pulse rate by more than a threshold amount, operating the pulse generator source to provide, during an additional training period of time, an additional plurality of energy pulses to the myocardium at the target frequency.

The methods of the disclosure are also useful in electrochemically controlling limb movement in a subject. Such methods include: contacting sciatic nerve with one or more devices of the disclosure as described herein; and operating a pulse generator source to provide, during a period of time, a plurality of electrochemical energy pulses to the sciatic nerve at the target frequency.

In order to use the devices described herein to facilitate electrochemical manipulation of the sciatic nerve, in the devices of the disclosure the membrane is configured to be placed in contact with sciatic nerve cells such that the one or more devices are in contact with sciatic nerve cells.

The particulars shown herein are by way of example and for purposes of illustrative discussion of certain embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice. Thus, before the disclosed processes and devices are described, it is to be understood that the aspects described herein are not limited to specific embodiments, apparatus, or configurations, and as such can, of course, vary. It is also to be understood that the terminology used herein is for the purpose of describing particular aspects only and, unless specifically defined herein, is not intended to be limiting.

The terms “a,” “an,” “the” and similar referents used in the context of describing the invention (especially in the context of the following embodiments and claims) are to be construed to cover both the singular and the plural, unless otherwise indicated herein or clearly contradicted by context.

All methods described herein can be performed in any suitable order of steps unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

As will be understood by one of ordinary skill in the art, each embodiment disclosed herein can comprise, consist essentially of or consist of its particular stated element, step, ingredient or component. As used herein, the transition term “comprise” or “comprises” means includes, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the embodiment to the specified elements, steps, ingredients or components and to those that do not materially affect the embodiment.

All percentages, ratios and proportions herein are by weight, unless otherwise specified.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

Groupings of alternative elements or embodiments of the disclosure are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Some embodiments of various aspects of the disclosure are described herein, including the best mode known to the inventors for carrying out the methods described herein. Of course, variations on these described embodiments will become apparent to those of ordinary skill in the art upon reading the foregoing description. The skilled artisan will employ such variations as appropriate, and as such the methods of the disclosure can be practiced otherwise than specifically described herein. Accordingly, the scope of the disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

### EXAMPLES

Certain aspects of the disclosure are illustrated further by the following examples, which are not to be construed as limiting the disclosure in scope or spirit to the specific methods and materials described in them.

### Methods

Hierarchical porous carbon film preparation. Resol (low-molecular) was prepared by crosslinking of phenol and formaldehyde, using methods from the literature (Meng, Y. et al., Angewandte Chemie International Edition 44, 7053-7059 (2005)). Pluronic block copolymer F127 (template) and phenolic resol (carbon source) were mixed at ratio of 1:2 into an ethanol solution. The precursor solution was stirred for 1 hour before use. Vesicle structures were constructed using silica nanosphere templates. 200 nm-diameter silica nanospheres (NanoComposix, 10 mg/ml) were surface modified with a dopamine layer, according to a literature method (Liu, R. et al., Angewandte Chemie International Edition 50, 6799-6802 (2011)). The modified nanospheres were then added into precursor solution and mixed until a homogeneous mixture formed. Silicon wafer (Nova Electronic Materials, p-type, 600 nm thermal oxide SiO₂) was cut into small pieces with suitable sizes (e.g. 2 cm×4 cm) and cleaned by O₂ plasma (Plasma Etcher, PE100) at 100 W for 2 minutes. The precursor solution with silica nanospheres was spin-coated (Laurell, WS-650 spin coater) onto the surface-cleaned silicon at 1500 rpm for 45 s. Multiple layers were formed by leaving the silicon wafer at room temperature for 10 minutes and then repeating the spin-coating. Then pure precursor solution was spin-coated onto the substrate at 3000 rpm for 45 s. The wafers were kept immobile for 4-6 h at 25° C., then baked in an oven for 24 h at 100° C. After baking, the wafers were transferred into an inert argon atmosphere and heated at 700° C. (temperature rise rate at 5° C./min) for 30 min. The thin film was etched off the silicon wafer and nanospheres were etched by submerging the wafers in buffered hydrofluoric acid (HF) for 8 h. The thin film was rinsed with deionized (DI) water 6 times and dried prior to further characterizations (e.g. SEM and nanoindentation).

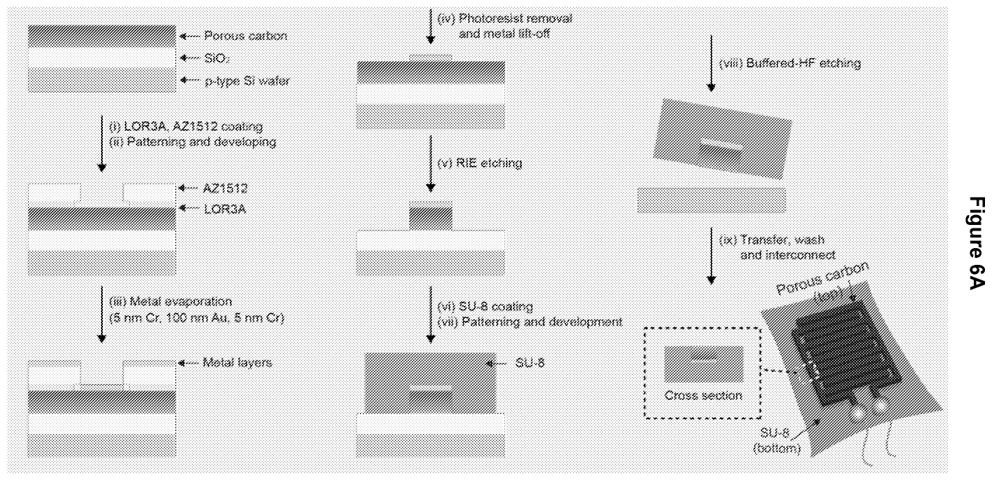

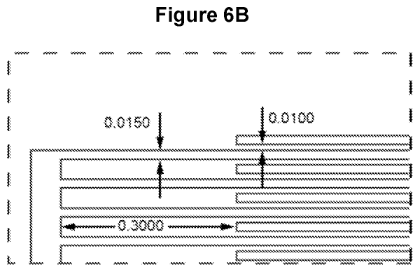

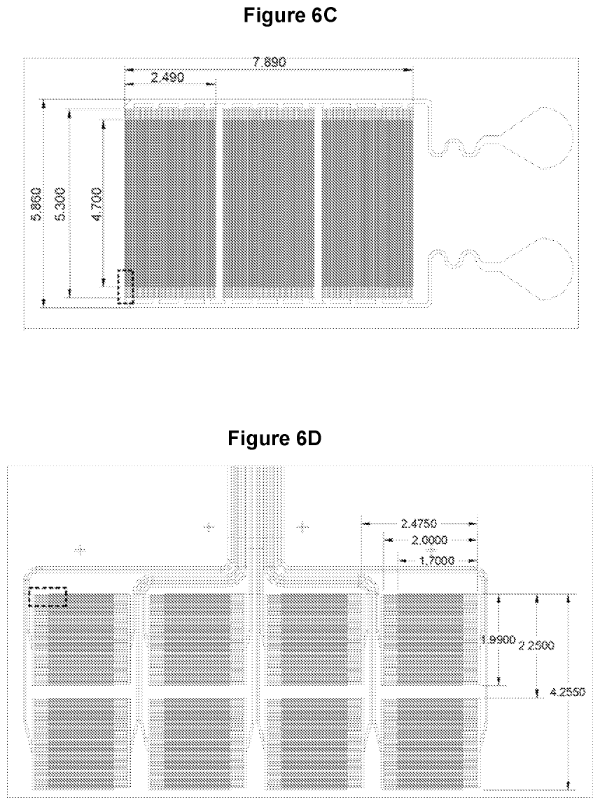

Device design. CAD schematics of comb-like devices are shown in FIG. 6. The pattern of interdigitated electrodes was consistent in each of the fabricated devices (FIG. 6b). Electrodes had a width of 15 μm with 10 μm spacing between them and 300 μm distance to the edge of the comb. The single channel device (FIG. 6c) was comprised of 150 pairs of electrodes connected to 2 large pads, allowing for manual connection to jumper wires. The multichannel electrode (FIG. 6d) had 8 sites arranged in 4 columns and 2 rows, and each site had 40 pairs of electrodes. Traces coming from the electrode sites were connected to 16 pads (2.25 mm length, 0.3 mm width, 0.5 mm pitch) matching a ZIF connector (FH12A-16S-0.5SH(55), Hirose Electric Co Ltd.). SU-8 patterns were designed with perforations in the area outside of the electrodes to increase the surface area available to buffered HF and to reduce the time required for SiO₂ etching. However, we did not notice significant difference in fabrication and performance of devices with and without perforations.

Device fabrication. A hierarchical porous carbon film obtained on p-type wet thermal oxide silicon wafer was used as a substrate for fabrication. After cooling, a standard photolithography procedure was applied to make the desired pattern on the hierarchical porous carbon. A schematic of the microfabrication protocol is shown in FIG. 6a. Metal layers act as a hard mask for reactive-ion etching, and as a conductive and mechanical support for the carbon films. Chromium was used to improve adhesion between material layers. 5 nm Cr, 100 nm Au and 5 nm Cr layers were evaporated on the patterned surface using an e-beam evaporator (EvoVac, Angstrom Engineering), and extra carbon was removed by reactive-ion etching (Oxford Instruments PlasmaPro, NGP80). The supporting SU-8 layer had a thickness of approximately 10 μm. Patterns were exposed using a direct writer (MLA150, Heidelberg). The pattern on the SU-8 layer was etched from the substrate with buffered HF and transferred into DI water, afterwards washing the device with DI water 6 times. For free standing devices, fabrication electrodes were transferred onto polyimide film and allowed to dry. For single site devices, jumper wires were connected to the pads using conducting silver paste (Ted Pella) and after 24 h of drying, the connections and excess of connecting traces were insulated using silicone glue (Kwik-Sil, World Precision Instruments). For multisite devices, excess of traces was partially insulated using silicone glue. The connector header was strengthened with polyimide tape, cut to appropriate dimensions, and inserted into the ZIF connector. For cell and tissue culture, the devices were directly transferred onto glass microscope slides or into glass-bottom culture dishes. After ensuring even placement, the devices were allowed to dry and partially adhere to the glass. Next, jumper wires were connected using silver paste and left to dry for 24 h, after which the device was fixed to the dish and connections insulated with silicone glue. Devices were sterilized with oxygen plasma (100 W for 1 min) before cell or tissue culture.

Raman spectroscopy. Raman spectra were recorded using a LabRAM HR evolution system (Horiba, Japan), and the mapping was done in the ultralow frequency module using a 532 nm laser.

Electrochemical measurements: The electrochemical property of the porous carbon material was examined by the cyclic voltammetry (CV), which were performed over a wide range of scan rates at room temperature or 37° C. in various electrolytes. A potentiostat (SP-200, BioLogic) with the three-electrode cell was used, in which a Pt-wire was used as the counter electrode, a Ag/AgCl electrode (1M KCl) as the reference electrode, and a micro-supercapacitor device was used as the working electrode. Areal cell capacitance (C) was calculated from the cathodic phase of CV by C=(∫I dv)/(sV A), where I is the current, s is the scan rate, V is the potential window, and A is area of the electrode. Galvanic charge/discharge measurements were tested using two symmetric devices at different current densities and charging/discharging time in a two-electrode configuration. The voltage shown was the potential between the two symmetric devices.

Voltage transients. Voltage transients were measured using a potentiostat (SP-200, BioLogic), where a platinum electrode was used as a counter electrode and a Ag/AgCl (1 M) electrode was used as a reference. For the measurement, the carbon electrode was stabilized at 0 V versus Ag/AgCl for 1 ms in PBS at room temperature. 700 μs long cathodic and anodic current pulses were delivered to the electrode with the interpulse delay of 28 μs. The most negative (E_{mc}) and positive (E_{ac}) polarization potentials were assigned 28 μs after the maximum of a respective peak to account for access voltage and instrument delay. The charge injection limit was taken as a maximum charge injected without exceeding the −0.6-0.6 V potential window.

Electron microscopy. Transmission electron microscopy (TEM, Tecnai F30, FEI) and scanning electron microscopy (SEM, Carl Zeiss, Merlin) were used to characterize the hierarchical porous materials and material/cell interfaces. CMs on the materials were fixed in 5% glutaraldehyde PBS solution for 30 min, washed in DI water, and then dehydrated with an increasing ethanol gradient from 30% to 98%. The samples were dried in a critical point dryer (Leica EM CPD300) and observed on the same SEM after coating with an 8 nm Pt/Pd metal layer on a sputter coater (Ted Pella, Inc.). The SEM was operated at a 2-kV accelerating voltage.

Mechanical test. Indentation modulus and hardness were measured by performing nanoindentation using a Hysitron 950 Tribolndenter in ambient conditions with a Berkovich indenter (three-sided pyramid-shaped diamond tip, tip radius ˜100 nm). All measurements were kept at a constant displacement of 200 nm. The data were analyzed using standard Oliver and Pharr (1) analysis to extract the reduced modulus (Er) and hardness by selecting upper fit at 95% and lower fit at 20%. The Young's modulus E of the samples was extracted based on Eq. (1), a general relation that applies to any axisymmetric indenter. The diamond tip has a Young's modulus E; =1141 GPa and a Poisson's ratio v; =0.07. Here, we assume the Poisson's ratio of the samples v=0.25, which has been widely used for amorphous carbon.

$$\frac{1}{{E}_{r}} = \frac{1 - {v}^{2}}{E} + \frac{1 - {v}_{i}^{2}}{{E}_{i}} \qquad ( 1 )$$

Finite element analysis of the electric potential distribution. The finite element analysis of the 3D electric potential distribution at the cross-section of the micro-supercapacitor-like device was performed using the AC/DC module of COMSOL Multiphysics software. The electric scalar potential, V, satisfies Poisson's equation, −∇·(ε₀ εᵣ ∇V)=ρ where ε₀ is the permittivity of free space, εᵣ is the relative permittivity, and ρ is the space charge density. The electric fields are obtained from the gradient of V: E=−∇V, and the displacement is defined as D=ε₀ ε_{f} E. To simplify the simulation (versus the actual device with three hundred prongs), a pair of five-prong comb-like electrode model was built with a gap of 10 μm and prongs of 200 μm length and 15 μm width. Prong width and gap width were consistent with the experimental setup. A relative voltage of 1 V was applied between left- and right-side set of electrodes. The medium was modeled as conductor with conductivity of 1.4 S/m and relative permittivity of 80, which correspond to approximate values for DMEM cell culture media. For comparison, the electric potential distribution of two planar electrodes with the same area was also calculated. The area of each electrode was equal to the total area of a single comb, and the gap width between the two planar electrodes was equal to the summation of the gaps in each comb-like electrode; as such, each electrode was of 75 μm width and 200 μm length with a gap of 50 μm between the two. A heat map was colored according to the surface electric potentials (V) with arrows indicating the electric field direction and strength.

Finite element analysis of von Mises stress. The finite element analysis of the von Mises stress was performed using the Structural Mechanics and Shell modules of COMSOL Multiphysics software. The geometry of the device was simplified as a block of SU-8 with dimensions of 0.5 mm×0.5 mm×0.01 mm and as 2 shells of either complete planar layers of gold (0.0001 mm) and carbon (0.0006 mm) or the shells in the comb-like shapes with electrode width of 0.015 mm and spacing of 0.010 mm. All materials were modelled as linearly elastic. Density, Young's modulus and Poisson's ratio were used to model material deformation and stress. Gold was modelled using COMSOL library values, SU-8 was modelled using literature values and the carbon layer was modelled using Young's modulus measured using nanoindentation, (Eᵢ=4.2 GPa) and approximate values of Poisson's ratio (vᵢ=0.25) and density (d=1600 kg/m³, graphite density excluding pore volume). For the simulation, edge boundaries of the SU-8 block were constrained and point pressure of 0.001 N was applied at the center of top boundary down the z-axis.

Cell culture. All animal procedures were conducted in complete compliance with and approval from the University of Chicago Institutional Animal Care and Use Committee (IACUC) Animal Care and Use Protocol. Hearts were excised from PO-5 neonatal rats into ice cold HBSS (without Ca²⁺ or Mg²⁺). The hearts were cut to small <1 mm piece, and then rinsed with HBSS to remove blood. A Pierce™ primary cardiomyocyte isolation kit (Thermo Fisher Scientific) was used for digesting the tissue according to manufacturer protocol. After isolation, the suspended cells (mainly CMs contaminated with cardiac fibroblasts) were pre-plated for 2 h, allowing fibroblasts to adhere to the tissue culture plate. Then the enriched CMs population was seeded onto the micro-supercapacitor device pre-treated with fibronectin (Sigma). The cells were allowed to sit in culture media (DMEM high glucose+10% FBS, 1% Glutamax and 1% penicillin-streptomycin) for 24 h, then the media was changed to CM-specific media (DMEM high glucose+10% FBS, 1% penicillin-streptomycin, and 0.1% growth supplement from isolation kit). This media prevented fibroblasts from proliferating and taking over the culture.

LIVE/DEAD Viability. CMs were cultured on the device for 3 days and then stained with green fluorescent calcein-AM (Life Technologies), red fluorescent ethidium homodimer-1 (Life Technologies) for 30 min. DAPI was included for nuclear counterstaining in dead cells. 100% EtOH treated cells for 20 min were included as a positive control. The as-stained cells were imaged using a Leica SP5 confocal microscope.

Nuclear staining assay. Primary rodent fibroblasts harvested from rat pup hearts (postnatal day 1-3) were seeded and cultured on top of sterilized carbon micro-supercapacitors with fibroblast culture medium (high glucose DMEM+10% FBS) for 36 hours in an environment of 37° C. and 5% CO₂. The seeded device was washed with PBS and then fixed with buffered 4% paraformaldehyde at room temperature. After permeabilization with 0.25% Triton X-100 in PBS, cells were counterstained with Hoechst 33342 (0.1 μg/ml) and imaged on Olympus inverted fluorescent microscope and Leica Confocal SP5 system. Positive control samples were prepared by treating fibroblasts with 1 mM hydrogen peroxide to induce apoptosis.

Lactate dehydrogenase (LDH)-cytotoxicity assay. Primary rodent fibroblasts harvested from rat pup hearts (postnatal day 1-3) were seeded and cultured on top of sterilized carbon micro-supercapacitors with fibroblast culture medium (high glucose DMEM+10% FBS) in an environment of 37° C. and 5% CO₂. The culture medium supernatant was harvested at 24 (day 1, D1) and 48 hours (day 2, D2). LDH activity in the medium supernatant was measured using Pierce LDH Cytotoxicity Assay Kit (Thermo, US). Cycloheximide (CHX) at the concentration of 10 μg/mL for 24 hours was used to induce cell death as a positive control for this assay. LDH cytotoxicity percentage was calculated by (LDHₛₐₘₚₗₑ−LDH_{baseine})/(LDHₘₐₓ−LDH_{basebne})×100%, where LDHₛₐₘₚₗₑ is the corresponding LDH release from the CHX-, device-, and SU-8-treated samples, LDH_{baseline} is the spontaneous LDH release activity, and LDHₘₐₓ is the maximum LDH activity detected in whole cell lysates.

Evaluation of in vivo biocompatibility in mice. A piece of carbon micro-supercapacitor (0.5 cm×0.5 cm) was surgically implanted under the dorsal skin of 6 to 8-week-old C57BL/6J mice through incisions, which were later closed with sutures. Mouse body weights were recorded on a weekly basis. At 1 or 4 weeks, mice were euthanized, and skin tissue surrounding the implant site was excised and fixed with buffered formalin for histology. The excised tissues were processed and stained with hematoxylin and eosin (H&E) for histopathological evaluation at university human tissue resource center.

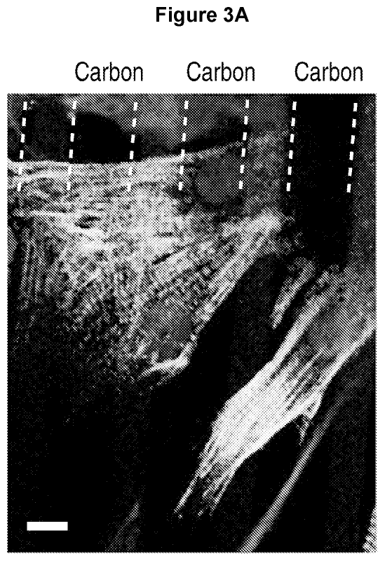

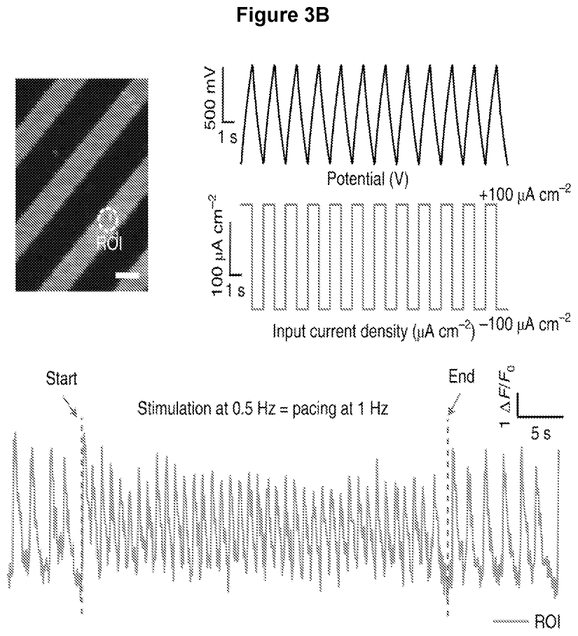

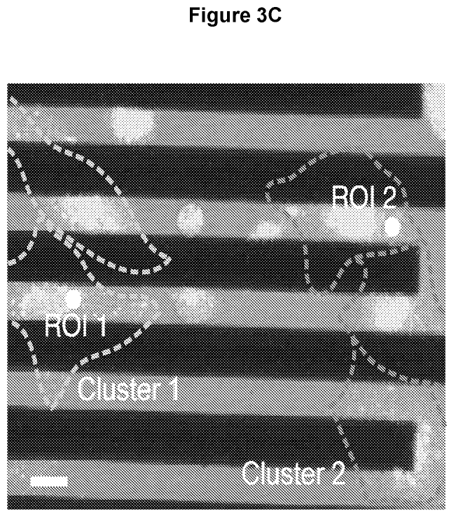

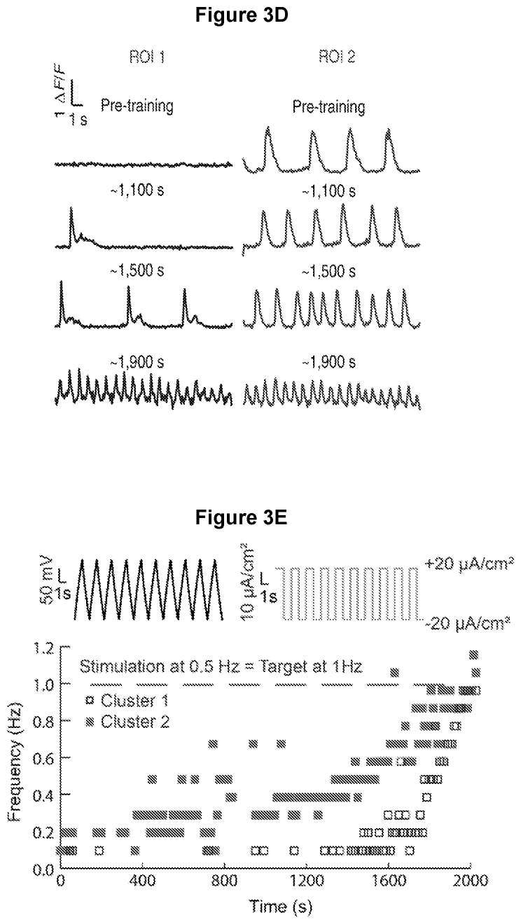

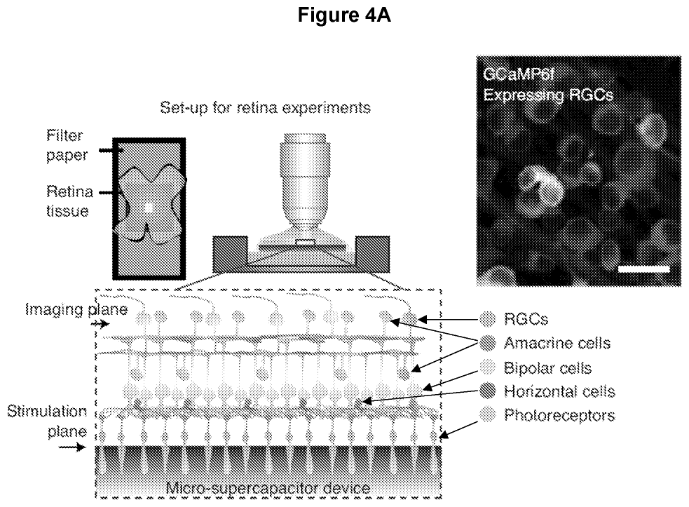

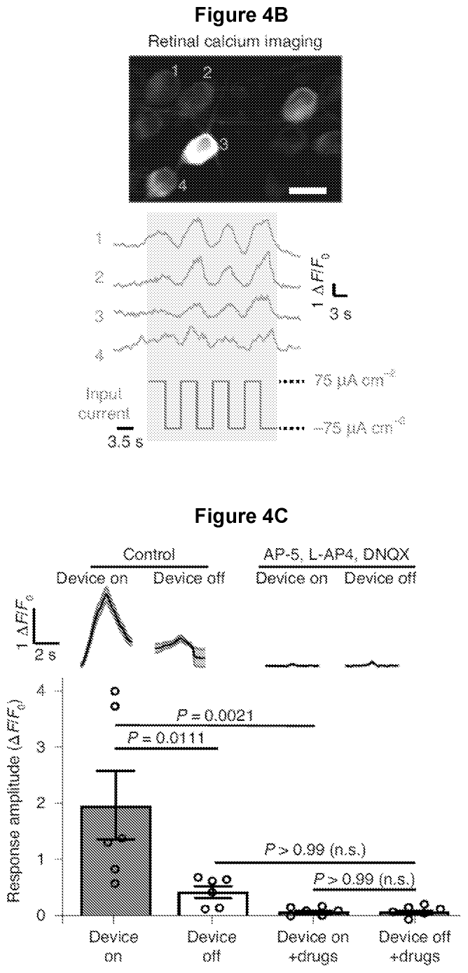

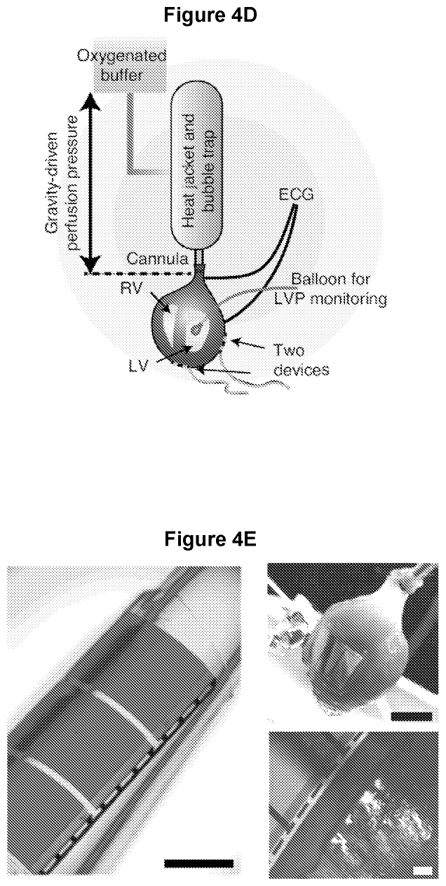

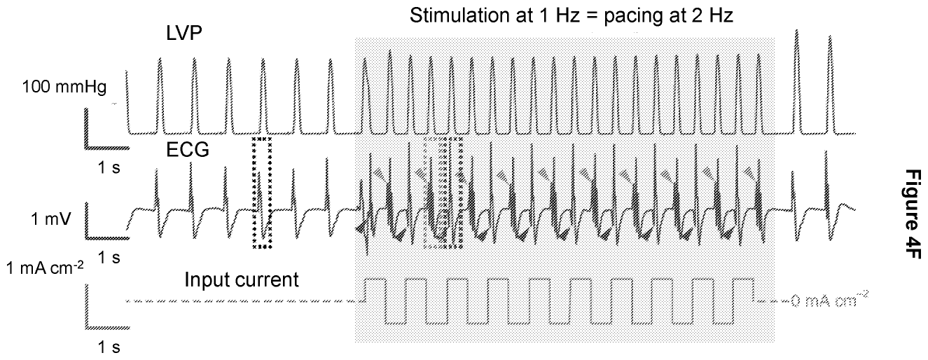

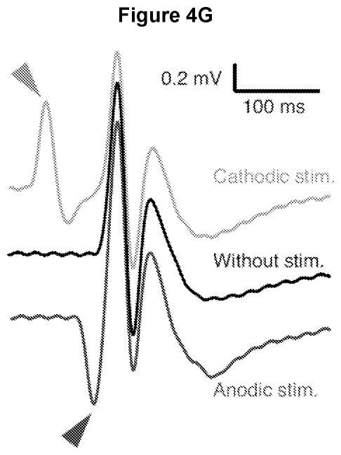

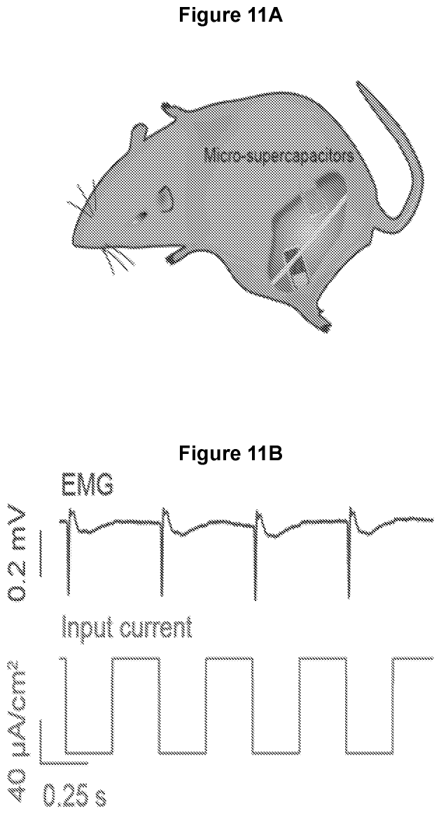

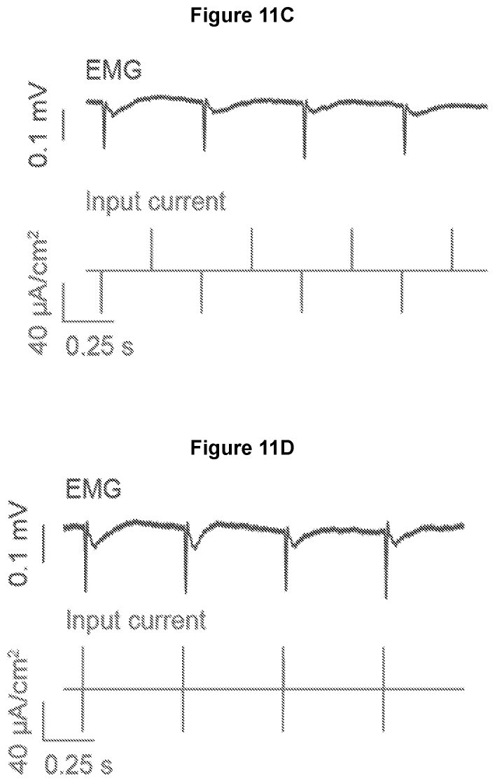

Device connections for the bioelectrical stimulations. Devices were generally connected in a two-electrode (i.e., working electrode and counter electrode) configuration, where the counter electrode was connected to the ground. Square current waveforms (FIGS. 3b, 3e, 4b, 4f, and 4h (left); FIG. 11) were delivered using a source meter (Keithley 2636A, Tektronix, Inc.) controlled using a LabVIEW program (National Instruments). Current pulses (FIGS. 4h, middle and right) were delivered using a potentiostat (SP-200, BioLogic). The electric potential was reported as the potential between the two electrodes. In the in vitro cardiac training (FIGS. 3b-e) and the ex vivo retinal experiments (FIG. 4b), the square current waveforms were applied to the two interdigitated electrodes within the same carbon micro-supercapacitor-like device (i.e., one interdigitated electrode as the working electrode and the other interdigitated electrode as the grounded counter electrode). In the stimulation of isolated hearts (FIGS. 4f and 4h) and sciatic nerves (FIG. 11), we used two carbon micro-supercapacitor-like devices (i.e., with one device as the working electrode, and the other device as the grounded counter electrode). For the traces reported in this paper, and the square current waveforms or the current pulses were applied between the two macroscopic devices.

Calcium sensitive dye. CMs were treated with calcium sensitive dye (2 μM Fluo-4, AM, cell permeant, Thermo Fisher Scientific) for 30 min at 37° C. Cells were rinsed and incubated for 30 min to allow complete de-esterification. The treated cells were then visualized with a Leica SP5, STED-CW Super-resolution Laser Scanning Confocal.

Analysis of pacing frequency in subthreshold stimulation experiments. Movies showing fluo-4 fluorescence in cells and colonies were segmented by hand in ImageJ, using the built-in ROI manager to generate a binary mask that was true for every pixel that was within an oscillatory cell. Normalized change in fluorescence dF/F₀ movies were produced using a freely available ImageJ plugin. The remainder of the analysis was conducted using a home-built routine written in Python 3.7. For a given cell at a given time point, the signal was calculated as the average dF/F₀ pixel intensity within the cell. The full length of the signal was subdivided into sections of 100 frames duration, for frequency and correlation analysis. Changes in oscillation frequency for individual cells and groups thereof were characterized by plotting the magnitude of the Fourier transform of each section and observing the frequency with the highest power. Because some cells were not oscillatory for some of the time sections, we implemented a power threshold of 150 and only plotted frequencies exceeding this threshold. Representative videos of dF/F₀ at the beginning (t=0-31.395 s) and at the end of stimulation (t=1900-1931.395 s) are provided as Supplementary Video 1 and Supplementary Video 2. Supplementary Videos 1-4 are available for viewing Supplementary information for Fang, Y. et al, “Micelle-enabled self-assembly of porous and monolithic carbon membranes for bioelectronic interfaces,” Nature nanotechnology (2020); available at https://doi.org/10.1038/s41565-020-00805-z.

Retina slice. Vglut2-IRES-Cre mice (016963-Sc17a6^{tm2(cre)Lowl}/J) and floxed Ai95(RCL-GCaMP6f)-D mice (028865-Gt(ROSA)26Sor^{tm95.1(CAG-GCaMP6f)Hze}/J) were crossed to each other to obtain hybrid Vglut2-IRES-Cre/GCaMP6f transgenic mice. Mice of both sexes (postnatal days 21-35) were used for retinal calcium imaging experiments. Mice were anesthetized with isoflurane and decapitated after dark adaptation. Under infrared illumination, retinas were isolated from the pigment epithelium in oxygenated Ames' medium (Sigma-Aldrich, A1420), cut into dorsal and ventral halves, and mounted on filter papers as described in the literature. Retinas were kept in the dark at room temperature in Ames' medium bubbled with 95% O₂/5% CO₂ until use (0-7 h). Glass coverslips with adhered micro-supercapacitor devices were used as the bottoms of the imaging chamber. During imaging, retinas were placed on top of micro-supercapacitor devices and gently pressed against the surface using a platinum (Pt) wire weight and perfused with oxygenated Ames at 32-33° C. Cells were visualized with infrared light (>900 nm) and an IR-sensitive video camera (Watec). Calcium transients from GCaMP6f expressing retinal ganglion cells were recorded by a custom-built two-photon microscope (Bruker) equipped with a Ti:sapphire laser (Chameleon Ultra II; Coherent Technologies) tuned to 920 nm. Data were acquired using PrairieView software from a 100 μm×100 μm field of view with an acquisition rate of ˜15 Hz. Raw frames were uploaded onto ImageJ software in which ROIs were manually drawn to enclose the soma of each GCaMP6f-expressing cell and a background region where there was no detectable GCaMP6s expression. Using custom MATLAB scripts, we calculated the average intensity over time for all ROIs and subtracted the background trace from light-responsive somatic traces to remove noise. The calcium traces were resampled to 75 Hz and smoothed using a moving average sliding window of 25 data points (˜333 ms). For each stimulation protocol, the average dF/F₀ was calculated for every cell.

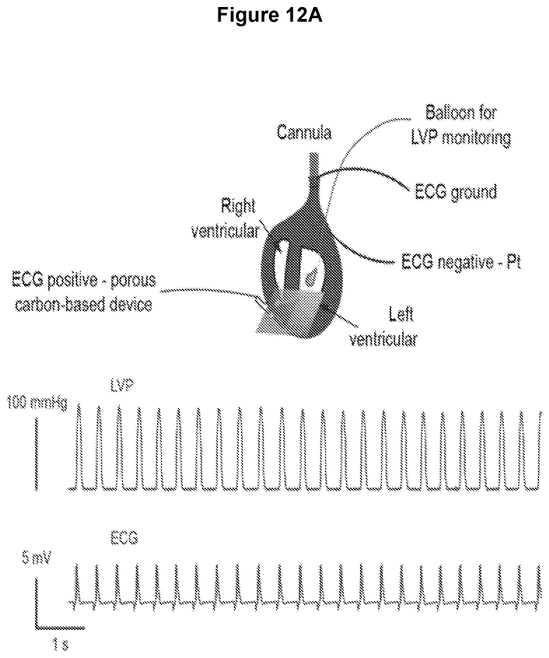

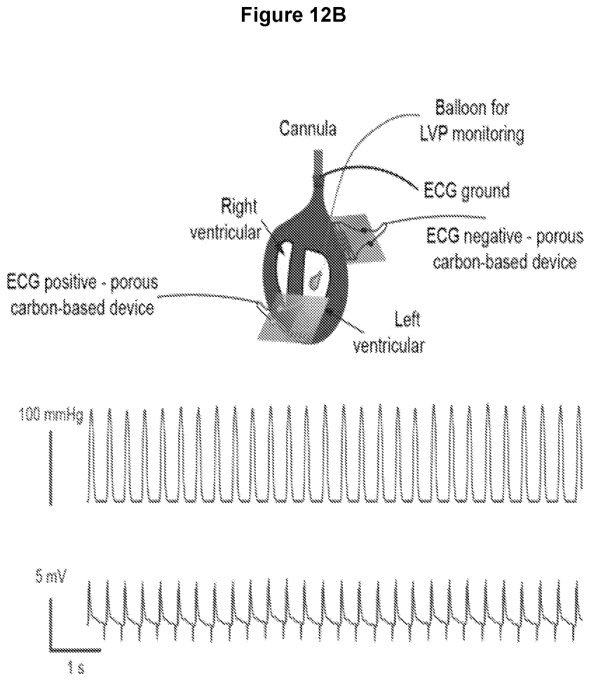

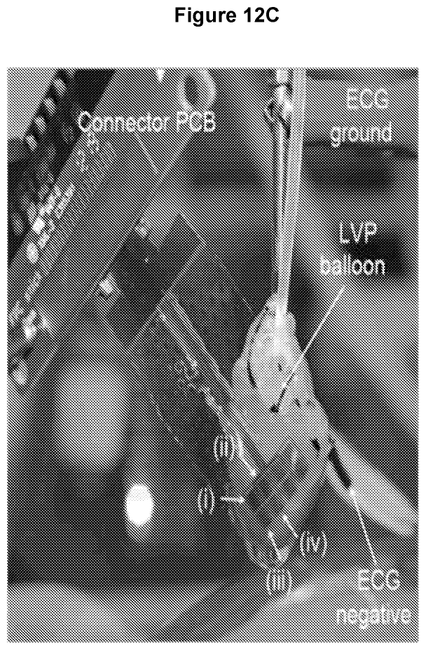

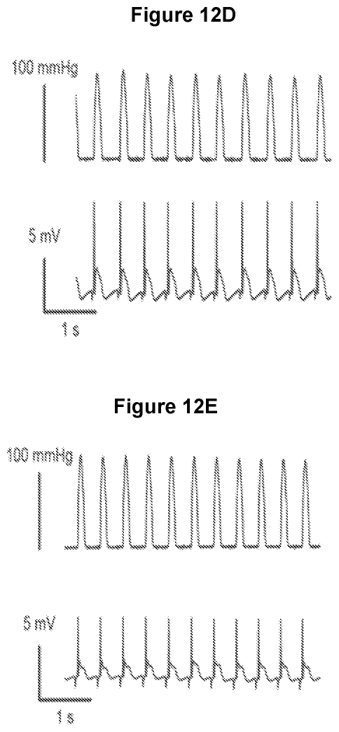

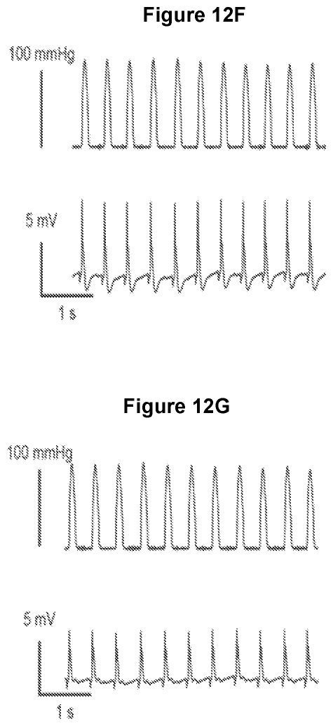

Isolated heart. An adult rat was heparinized (1,000 IU/kg IP) and anesthetized using open-drop exposure of isoflurane in a bell jar configuration. The heart was removed and placed in ice cold HBSS buffer, and the aorta was cannulated in preparation for use in a Langendorff setup. Oxygenated HEPES-buffered Tyrode's solution (containing, in mM, NaCl 126, KCl 5.4, Glucose 10, HEPES 10, MgCl₂ 1, CaCl₂ 2, MgSO₄ 1.2, NaH₂PO₄ 0.39; bubbled with 99.5% O₂; pH 7.3) was perfused through the cannulated aorta. The perfusion was passed through a heating coil and bubble trap (Radnoti), and the heart was placed in a water-jacketed beaker (Fisher Scientific) to maintain a temperature of 37° C. The perfusion pressure was maintained at 80-100 mmHg by adjusting the height of the IV bag containing the perfusion buffer. The perfusion and left ventricular pressures (LVP) were monitored using a BP-100 probe (iWorx) connected to the perfusion line and a water filled balloon inserted to the LV, respectively. For ECG recordings, needle electrodes were positioned on the LV wall and aorta and connected to a C-ISO-256 preamplifier (iWorx). All signals (perfusion, LVP and ECG) were amplified using an IA-400D amplifier (iWorx) and interfaced with a PC using a DigiData 1550 digitizer with pClamp software (Molecular Devices). Two devices were placed on the heart; one below the heart's apex, and the other covering the LV wall. Current waveforms were applied to the devices and the clear ECG artifacts were used to time the stimulation with the recording. To avoid the electrical noise introduced by the devices, we recorded the LVP to monitor the contraction rate of the heart during stimulation. Recordings from supercapacitor devices (FIG. 12) were achieved with C-ISO-256 preamplifier (iWorx) as in a regular ECG setup, but with devices connected as input electrodes.

In vivo rat nerve stimulation. Seven-week-old rats were deeply anesthetized with ketamine (100 mg/kg) and xylazine (10 mg/kg) via intraperitoneal injection. The fur was removed from the hindquarters using a surgical clippers and hair removal cream. A semi-circular incision across the midline was made in the skin, and the fascial plane was opened between the gluteus maximus and the anterior head of the biceps femoris, thereby exposing the sciatic nerve. In this setting, two devices were used. One device was placed under the sciatic nerve and the other under the rat's skin. For intermittent limb stimulation, the two devices were paced under the two sciatic nerves.

### Example 1: Synthesis and Characterization of Carbon Membrane

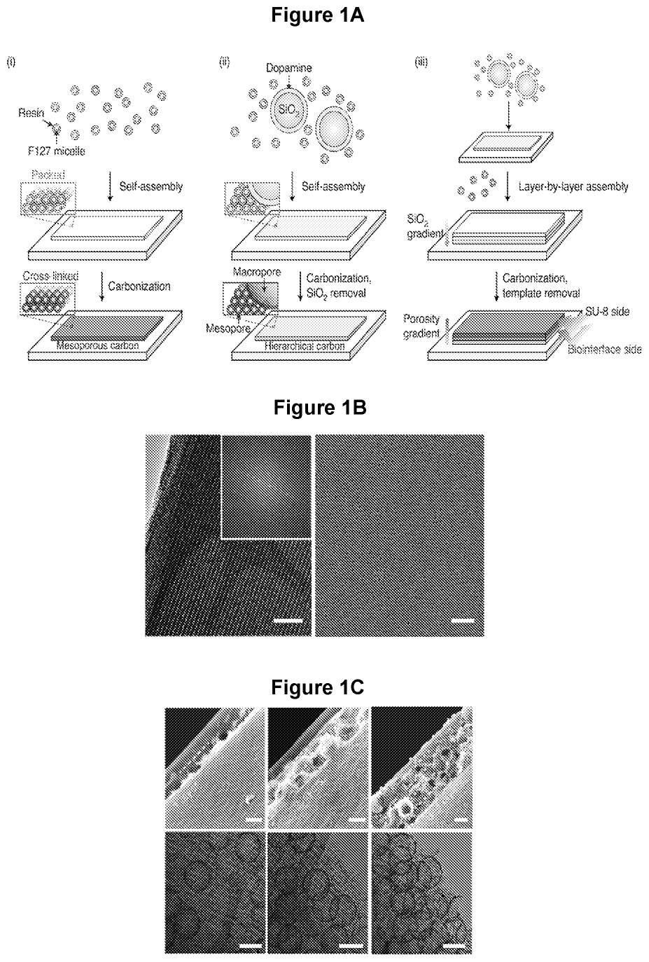

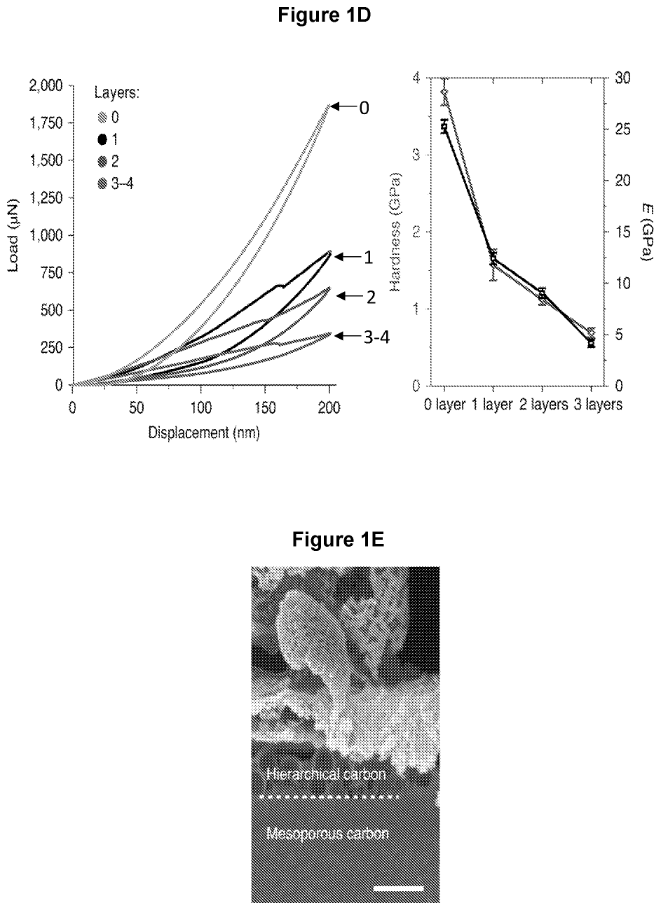

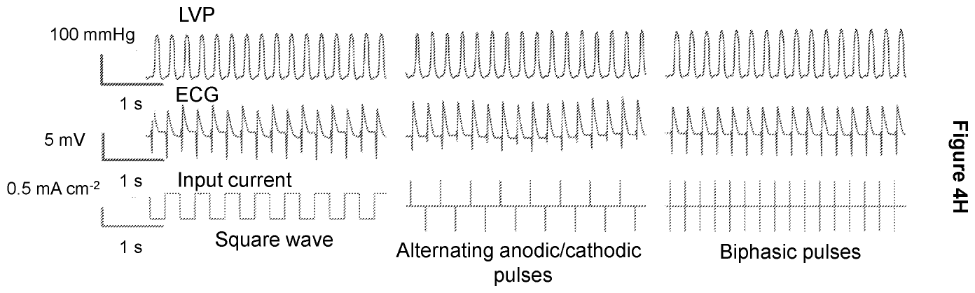

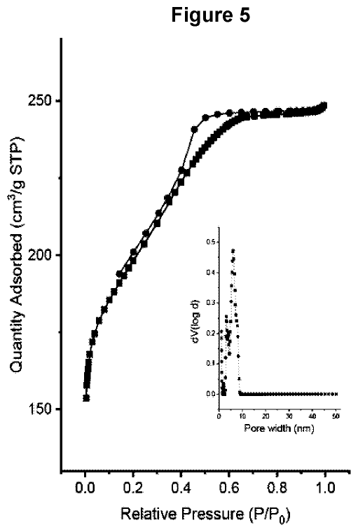

We adopted a bottom-up approach for the direct preparation of monolithic (i.e., binder-free) and hierarchical carbon membranes. Nanoscale micelles were prepared through biphasic interaction between triblock copolymer Pluronic F127 (the primary organic template) and resin (the primary carbon precursor) in ethanol. The micelle solution was spin-coated onto the thermal oxide of a silicon wafer. Following solvent evaporation-induced self-assembly (FIG. 1a(i)), the packed micelles were carbonized completely into mesoporous carbon membranes. The carbonization process leads to the crosslinking of carbon precursors and the formation of monolithic membrane structures. The process yields highly ordered mesostructures with a uniform pore size of 7 nm, as shown in transmission electron microscopy (TEM) images (FIG. 1b). Nitrogen adsorption/desorption measurements further confirmed a narrow pore size distribution (FIG. 5).

To reduce the stiffness of carbon films for improved compliance with soft biological interfaces, we introduced an inorganic template for the creation of a macroporous layer. Addition of ˜200-300 nm-sized silica (SiO₂) spheres coated with dopamine into the Pluronic F127 and resin mixture during the membrane preparation (FIG. 1a(ii)) introduced macroporous (i.e., with pore size >50 nm, based on the IUPAC terminology) structures (FIG. 1c). The role of dopamine here is to stabilize dispersion of SiO₂ spheres in the micelle solution and to provide an additional carbon source. The hierarchical porous carbon preparation scheme permitted layer-by-layer assembly (FIG. 1a(iii)) of mesoporous carbon by spin coating, where the thickness and porosity of individual layers can be controlled. Subsequent buffered hydrogen fluoride (HF) treatment removes the SiO2 templates and releases the membrane. While the mesoporous film had a Young's modulus and hardness of 25.30 GPa and 3.82 GPa respectively, addition of ˜700 nm of the macroporous layer reduced these values to 4.20 GPa (modulus) and 0.69 GPa (hardness) (FIG. 1d). The highly porous structures in the carbon-based membranes led us to hypothesize that electrochemical devices made from them may display efficient capacitive charging and discharging, which may be useful for biological modulation when biointerfaces are formed (FIG. 1e).

### Example 2: Device Fabrication and Characterization

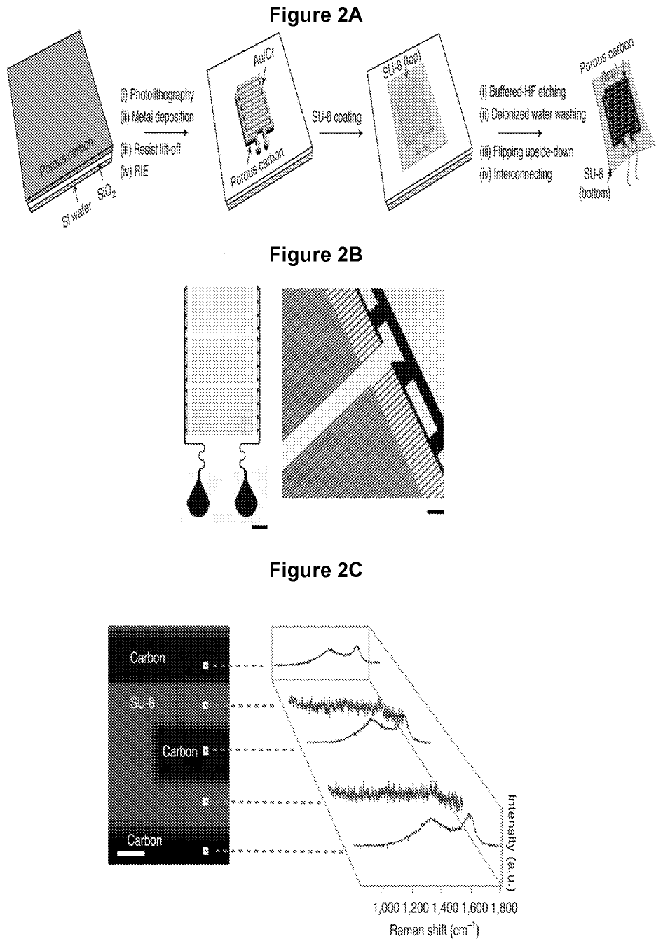

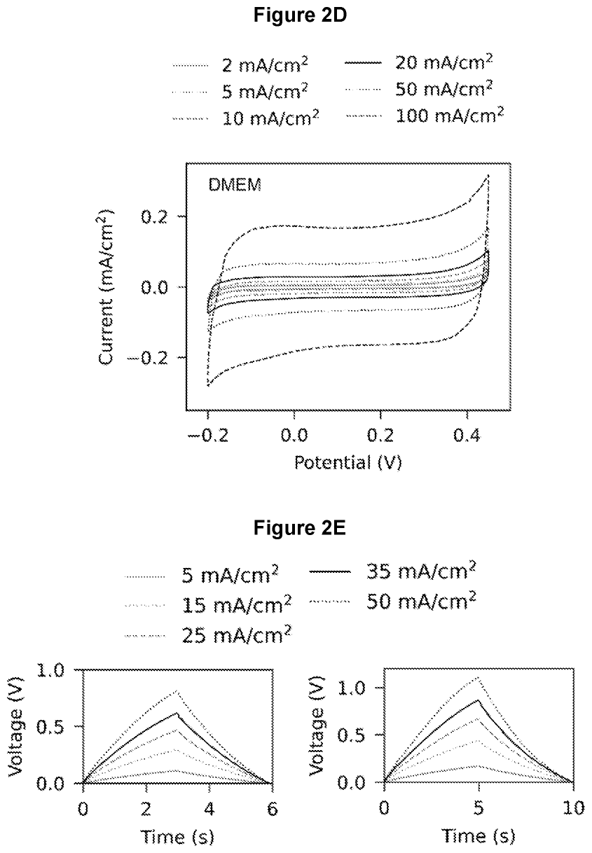

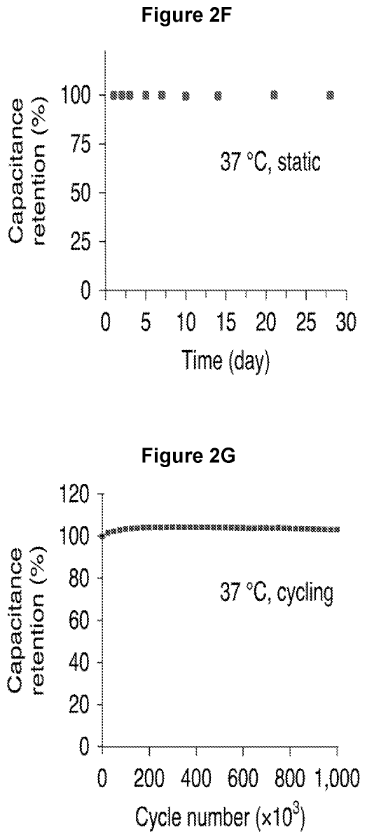

We fabricated the device in a micro-supercapacitor-like design and over an SU-8 substrate (˜10 μm typical thickness). The SU-8 think film is chosen (FIGS. 2a and 2b; FIG. 6) because it is photo-patternable, mechanically flexible, and chemically stable, and it has been commonly applied as a substrate or encapsulation material in flexible electronics. Since SU-8 is incompatible with the carbonization conditions under high temperature, all photolithography processes have to be performed on the fully carbonized membrane. To avoid difficult substrate transfer steps, we followed an ‘upside-down’ fabrication method (FIG. 2a; FIG. 6a), where the last step releases the device from the substrate and exposes the side for potential biointerfaces (i.e., the original interface between the thermal oxide and the carbon, FIG. 1a(iii)). This fabrication technique requires that the softer layer (i.e., the layer that forms direct biointerfaces) be on the bottom of the as-made membrane, hence the micelle-enabled layer-by-layer assembly has to start from the layer that can yield macropores. To form interdigitated electrodes, we used patterned metals layer as the mask for carbon etching as well as the electrical conductor to the carbon-based porous biointerfaces (FIG. 2a; FIG. 6a). We also incorporated sub-millimeter to millimeter diameter holes into the SU-8 substrate to facilitate the device lift-off from the silicon wafer, and to improve the conformal device wrapping over tissue or organs (FIG. 2b). By shrinking the feature size for interdigitated patterns, we were able to produce multichannel micro-supercapacitor-like devices. Raman spectra mapping showed carbon peaks at 1330 and 1590 cm⁻¹ only in the patterned region, confirming the presence of carbon membrane (FIG. 2c).

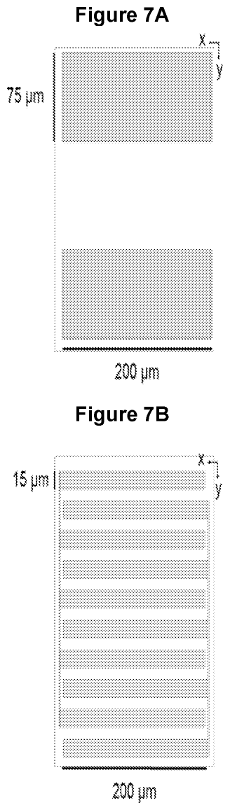

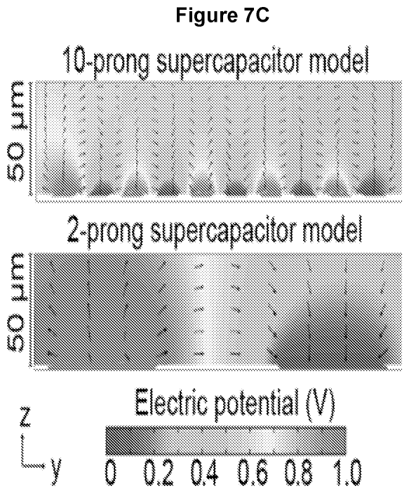

Mechanical simulations for puncture deformation showed that compared to the uniformly-covered multilayered device, the interdigitated pattern can reduce the maximum von Mises stress present in both the carbon and metal layers, suggesting a mechanical justification of the micro-supercapacitor-like device. We also performed electrostatics simulations to model the electric potential at the surface of the device and between the interdigitated electrodes (FIG. 7). Comparing a 2-prong and a 10-prong electrode model with the same total electrode area, the 10-prong electrode geometry yields a more confined electrical potential distribution at the cross-section (FIG. 7c). This is reminiscent of the local return electrode designs for the photovoltaic devices used for retinal implants. We speculate that this confined z-axis electrical potential may be beneficial for stimulation and interfacing with cell monolayers in vitro or tissues with multilayered circuit organization (e.g., retina).

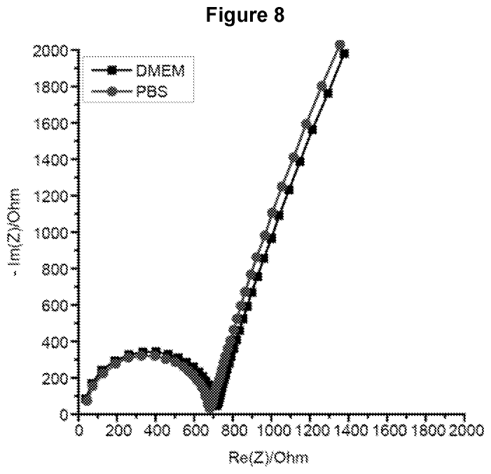

Without any binder or additives, we next conducted electrochemical tests using several physiological solutions for electrolytes. The electrochemical performance of the porous carbon membranes was analyzed by cyclic voltammetry (CV) and galvanostatic charge/discharge techniques in various electrolytes (FIGS. 2d and 2e). In Na₂SO₄ electrolyte solution, the device showed near-rectangular CV profiles up to a scan rate of 100 mV/s, confirming that the device acted as an electrostatic double-layer capacitor. Notably, the devices also showed a near-rectangular CV profile in Dulbecco's Modified Eagle Medium (DMEM) up to a scan rate of 100 mV/s, demonstrating that the capacitor behavior was maintained even in cell culture media (FIG. 2d). Areal specific capacitances calculated from the CV profiles were comparable to those of other supercapacitors or micro-supercapacitors (Table 1). Electrochemical impedance spectroscopy (EIS) tests revealed low equivalent resistances of ˜680Ω and 715Ω of the device in phosphate-buffered saline (PBS) and DMEM solutions, respectively (FIG. 8), suggesting good charge transport properties. Without optimization, the charge injection limit of the device is estimated to be at least ˜120 μC/cm², which is comparable to Pt and Pt/Ir alloy electrodes used in tissue stimulations (Table 2). Additionally, the electrode preserved a near-rectangular CV profile with a scan rates up to 4 V/s (FIG. S15a).

TABLE 1
Specific capacitance for different types of micro-supercapacitors.
The values shown below were acquired at different scan rates.

| Material | Specific capacitance (mF/cm²) |
|---|---|
| Porous C | 0.8 |
| Graphene | 3 |
| rGo-CNT | 2.8 |
| PEDOT | 1.0 |
| Onion-like carbon | 1.1 |
| Activated carbon | 0.9 |
| Photoresist-derived C | 0.5 |
| Present work | ~1-3 at 100 mV/s in different saline solutions |

TABLE 2
Charge injection capacity for different types
of electrodes used for biointerfaces.

| Material | Charge injection limit (mC/cm²) |
|---|---|
| Pt and PtIr alloys | 0.05-0.15 |
| Roughened Pt | 1.0 |
| CNT array | 1-1.6 |
| PEDOT:PSS | 2.71 |
| TiN | ~1 |
| IrOx | 1-5 |
| Present work | >0.12 |

Lastly, the intrinsic device stability in physiological solution was tested by submerging the device in 37° C. PBS solution for one month, during which no obvious change in capacitance rate was observed (FIG. 2f). The device also showed electrochemical and mechanical stabilities over the course of at least 1,000,000 charge/discharge cycles (FIG. 2g). Together, these results demonstrate that the device is promising for bioelectronic interfaces.

### Example 3: Cytotoxicity Evaluation

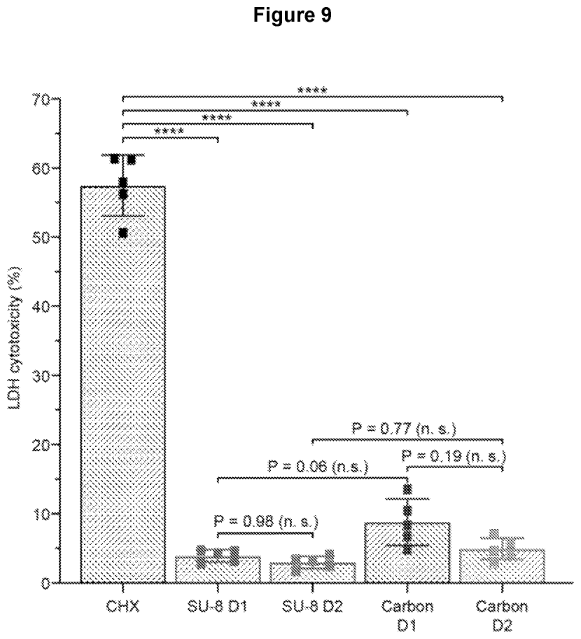

To gauge the biocompatibility of the device, we first confirmed the viability of CMs and primary rat cardiac fibroblasts (RCFs) cultured over the device. Live-dead assays showed that ˜100% of CMs were still alive after a 3-day culture. RCFs nuclear staining on the device showed healthy nucleus morphology, and no obvious nuclear changes due to cell death or apoptosis were observed. To have a more sensitive evaluation of the device in vitro biocompatibility, we conducted the lactate dehydrogenase (LDH) cytotoxicity assay using RCFs (FIG. 9). The LDH cytotoxicity percentages in SU-8 group on day 1 (3.91%) and day 2 (2.97%) indicate that SU-8 alone caused a very mild cytotoxicity in vitro, although SU-8 is widely recognized as a biocompatible material. When all the device materials are present (i.e., SU-8, porous carbon and metals), the LDH percentages are 8.77% and 4.93% for day 1 and day 2, respectively. However, the LDH levels in both the SU-8 and the device groups decreased on day 2 versus on day 1, suggesting that the cellular tolerance for these synthetic materials increased over time.

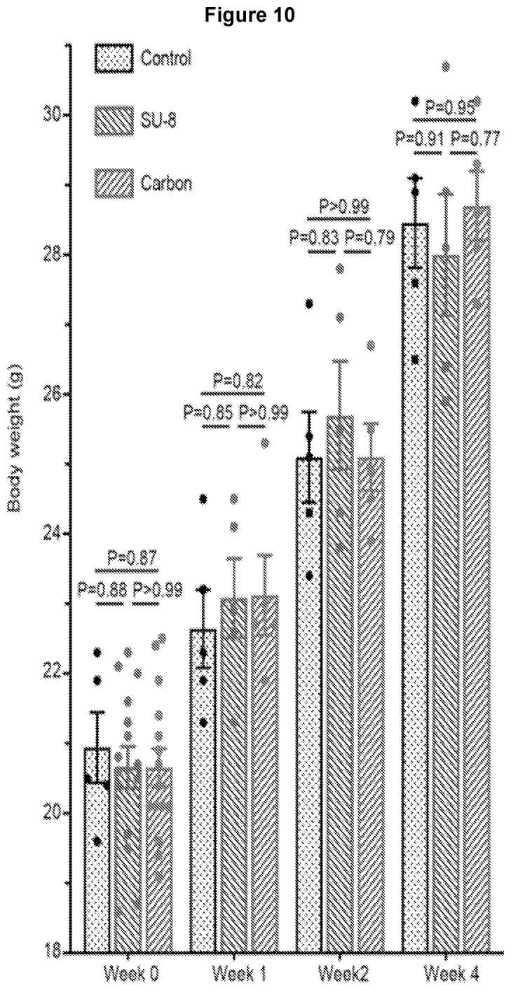

Hematoxylin and eosin stain of mice skin tissues surrounding the implanted devices showed that subcutaneous implantation caused some mild histological changes in week 1 and 4. No significant inflammation reactions and tissue damage were observed. The histological appearance of the skin tissue above the implanted device (i.e., the epidermis and the dermis) was normal in week 4, except for the mild thickening of subcutaneous connective tissue and mild recruitment of immune cells including macrophages and neutrophils. Additionally, we monitored mouse body weight and no weight loss was observed between control groups and device groups (FIG. 10).

### Example 4: Biological Training In Vitro

To study the ability of the device to modulate biological activities, we established a biointerface between the device and cultured CMs. Then, we verified expression of typical cardiac markers, such as cardiac troponin and connexin-43 (FIG. 3a), and we additionally confirmed that cells could spread out on the device surface and form subcellular interfaces. To evaluate how the charging/discharging cycles from the micro-supercapacitor-like device affect the CMs electrophysiology, we applied the anodic/cathodic square-wave current to the CM-interfacing devices and performed simultaneous calcium imaging to monitor electrical activity (FIG. 3b). Each side of the interdigitated electrodes acts as a lead and a square current waveform is applied between them (see Methods for details). Prior to stimulation, CMs were synchronized with a baseline rate of ˜0.67 Hz. Upon application of an input electric current waveform, overdrive pacing was achieved, and the contraction rate immediately synchronized to the pacing frequency (FIG. 3b). It is noteworthy that the pacing rate doubles that of the stimulation rate (i.e., the applied current frequency) (1 Hz pacing rate in FIG. 3b). This is reasonable if we assume that both the anodic and the cathodic phases of the electrochemical stimulation (from the same finger electrode area) can depolarize the CMs, although the action potentials (APs) may be initiated at different subcellular locations. In this experiment, the electrical stimulation from the interdigitated layout is advantageous as it can achieve single cell level modulation uniformly across the entire device area. The confined electrical potential around the finger electrodes may help improve the efficiency for stimulation as CM cultures are typically monolayer or sub-monolayer (i.e., it may be unnecessary to deliver an electric field far above the cell surface).

Although this ability to perform overdrive pacing of CMs may have promising therapeutic applications, we also wanted to demonstrate the utility of the device for in vitro cellular manipulation that would allow for basic mechanistic investigations. To this end, we applied current stimulation with subthreshold amplitude, which did not elicit a direct overdrive pacing response. FIG. 3c shows a field of view in which 5 CMs synchronized in 2 clusters were identified with very low spontaneous activity (˜0.2 Hz and 0 Hz, respectively). When a low amplitude current waveform was applied (5 times lower than for overdrive pacing), the CMs did not show an immediate response. However, when the stimulation was applied for a longer duration, a gradual increase in contraction was observed. After ˜1900 s of stimulation, the cells were evidently ‘upregulated’ by the current stimulation and their contraction rate increased to the target stimulation rate of 1 Hz (FIG. 3d). FIG. 3d shows representative calcium imaging traces from two regions of interest (ROI), before and during the training of the two cell clusters, and FIG. 3e shows gradual increase in contraction frequency over time. These results resemble the gradual increase in the rate of electrical activity previously observed in CMs upon subthreshold optical stimulation reported previously (Parameswaran, R. et al., Proc. Natl Acad. Sci. USA 116, 413-421 (2019)). While the cells within each cluster are synchronized throughout the training, the two clusters display negligible synchronization to each other before they reach the targeted frequency (Supplementary Video 1, Supplementary Video 2). This fact suggests that the subthreshold training displays cellular level heterogeneity and the stochastic events may be involved in this process. Although a detailed understanding of the precise underlying mechanism here requires further rigorous investigation, we postulate that repetitive stimulation alters the resting membrane potential of the CMs to the point that they are sufficiently depolarized to elicit action potentials (APs). This might happen in a fashion reminiscent of the ‘memory effect’, which refers to the way supra-threshold stimulation alters the excitability of cells and their resulting resting frequency. Because the porous carbon-based devices operate via capacitive charge injection, we were able to pace or train the CMs in a biocompatible way without generating faradaic reactions on the surface of the device. The lack of faradaic reactions will also prevent complications due to electrode hydrolysis, which would result in an increasing resistance over time, and in severe cases, device failure.

### Example 5: Biological Modulation at the Tissue and Organ Levels

We tested the efficacy of our device as a bio-modulator in both intact excitable tissues and ex vivo organs. Intact neural tissues represent highly crowded environments with non-neuronal factors, such as the extracellular matrix and glial interactions, that can influence neuronal activation. To determine whether the micro-supercapacitor-like device can modulate activity in intact neural circuits, we performed stimulation experiments on isolated mouse retinas. The laminated organization of the retina and its diverse neural circuit motifs make the retina an accessible model system to study brain circuit functions. Additionally, the use of retinal tissue allows us to stimulate physiologically relevant “input neurons,” i.e., the photoreceptors, and record activity from the “output neurons,” i.e., the retinal ganglion cells (RGCs) of a well-defined sensory circuit. In these experiments, we utilized retinas isolated from transgenic mice (Slc17a6^{tm2(cre)Lowl}/Gt(ROSA)26Sor^{tm95.1(CAG-GCaMP6f)Hze}) expressing the calcium indicator GCaMP6 in all RGCs. This enabled simultaneous monitoring of neural activity via multiple neurons. Micro-supercapacitor-like devices and interconnects were fixed on glass coverslips using silicone glue and used as bottoms for the retina perfusion chamber. Dissected retinas were then positioned with the photoreceptor layer facing the micro-supercapacitor-like device and the RGC layer facing upward (FIG. 4a). Using two-photon laser scanning microscopy, we recorded calcium transients from RGCs while stimulating the photoreceptor layer with micro-supercapacitor modulation. We used anodic/cathodic square current waveforms applied across the interdigitated electrodes within the device to modulate the neural activity of the ganglion cell layer. Current flow direction was periodically switched by alternating between the anodic and cathodic phases every 3.5 s. Throughout the stimulation process, large periodic transients could be observed across several RGCs. When the device was charged (i.e., during the anodic phase), RGCs exhibited large calcium transients; when the device was discharged (i.e., during the cathodic phase), the calcium levels in RGCs returned to resting levels (FIG. 4b). To corroborate that the micro-supercapacitor stimulation observed was due to activation of the glutamatergic pathway from photoreceptors to bipolar cells to RGCs, we applied a cocktail of glutamate receptor antagonists, including AP-5, L-AP4, and DNQX, to silence glutamate transmission in the retina. Upon glutamate receptor blockade, the large calcium transients could no longer be observed in RGCs during micro-supercapacitor stimulation (FIG. 4c). These results demonstrated that the charging and discharging stimulation at the supercapacitor-photoreceptor interface evoked changes in glutamate release from photoreceptor neurons and could therefore activate the retinal network.

Next, we evaluated the bioelectronic stimulation in tissues and organs that required the traditional charge injection configuration. The rat heart contained a ˜75 μm thick epicardium separating the CMs and the device. Therefore, a single micro-supercapacitor-like device, with just 10 μm spacing between the leads, was not sufficient to accumulate the depolarizing charge. In these experiments, one porous carbon-based device (i.e., working electrode) was placed on the left ventricular (LV) wall of a rat heart to apply different current waveforms, while the other device or a platinum wire (i.e., counter electrode and the ground) was placed on the right ventricular (RV) wall (FIG. 4d). We found that the two porous-carbon device configuration is demonstrably more efficient compared to a platinum wire as both flexible devices form good contacts with the heart surface (FIG. 4e). To lower the spontaneous heart rate, we removed the sinoatrial node along with the atria, which resulted in a slow atrioventricular node pace (˜1 Hz). Electrocardiogram (ECG) electrodes were placed on the aorta and the LV. To stimulate the isolated heart, we first applied anodic/cathodic current square waves with different frequencies as this can yield similar charging/discharging processes from a supercapacitor device (1 Hz, 0.5 mA/cm², FIG. 4f; and 2 Hz, 0.37 mA/cm², FIG. 4h). Upon stimulation, the heart immediately contracted at double the stimulation rate, i.e. 1 and 2 Hz stimulation frequencies corresponded to 2 and 4 Hz contraction frequencies, respectively (FIGS. 4f and 4h; Supplementary Video 3). This is similar to the observed in vitro pacing with a micro-supercapacitor device configuration, suggesting that both the anodic and cathodic stimulations from the working electrode can achieve a pacing effect. Due to the capacitive nature of our device and lack of faradaic charge injection, we hypothesize that the mechanism governing the electrical stimulation is similar to field coupling. FIG. 4g provides a closer look at a representative ECG recording of three different heart surface potentials. While no artifact was associated with the spontaneous one, we observed a positive/negative alternating artifact during the stimulation (FIGS. 4f and 4g, green and pink arrowheads, respectively). As the ECG was recorded from the aorta and the LV, the observed artifact may be attributed to the working electrode positioned on the LV. It should be noted that the artifact shapes and the positions are dependent on the device/ECG configurations, so they vary in different settings. As the elicited heart potentials were initiated near the onset of the anodic/cathodic phases of the square waves (FIG. 4h left), we next shrank the duration for each phase significantly while keeping the spacing of adjacent phases the same (i.e., 250 ms). The results from the alternating anodic/cathodic pulses (5 ms, FIG. 4h, middle) show effective overdrive pacing with 3.7 μC/cm² charge injection per phase/pulse. Finally, we also attempted the electrical pacing with conventional charge-balanced biphasic pulses and achieved efficient overdrive pacing at 0.7 μC/cm² charge injection in 1 ms pulse width (FIG. 4h, right).

Finally, to demonstrate the utility of the porous carbon-based device for in vivo neuro-modulation applications, we interfaced it with sciatic nerves. We used an acute setting in which the device was interfaced with the exposed nerve. FIG. 11 shows that application of anodic/cathodic cycles using two separate devices resulted in bioelectronic modulation of the nerve. When one device was interfaced with the sciatic nerve and the other device was interfaced with the rat's body, we observed that the associated limb was clearly moving with every cathodic phase of the current injection (Supplementary Video 4). This was further validated by electromyography (EMG) recordings from the rat limb, which showed large potential spikes that were synchronized to the cathodic phase.

A hierarchical carbon-based micro-supercapacitor-like device that is capable of biological modulation was developed. The porous structures and the interdigitated designs improve the device mechanics for biointerfaces and allow control over the current flow through capacitive charging/discharging. The device was successfully applied to in vitro, acute ex vivo, and acute in vivo modulations with the capacitive charging/discharging cycles or traditional current pulses. The device also shows promise with respect to long-term stability and reasonable biocompatibility. Other functions of this micelle-based and self-assembled bioelectronics device may incorporate the flexible electrical sensing, as shown in the ECG recording from isolated hearts (FIG. 12). Finally, while supercapacitors or micro-supercapacitors have been demonstrated in the past as implantable power elements, our findings suggest new utilities of these devices for future bioelectric therapeutics.

It is understood that the examples and embodiments described herein are for illustrative purposes only and that various modifications or changes in light thereof will be suggested to persons skilled in the art and are to be incorporated within the spirit and purview of this application and scope of the appended claims. All publications, patents, and patent applications cited herein are hereby incorporated herein by reference for all purposes.

1. A device comprising a carbon-based material comprising one or more monolithic porous carbon membranes, and a flexible substrate comprising one or more of polymers in which the material is distributed.

2. The device of claim 1, wherein the carbon-based material comprises at least one carbon membrane that is mesoporous or macroporous.

3. The device of claim 2, wherein the at least one carbon membrane is mesoporous and has a pore size in the range of 2 nm and 30 nm.

4. (canceled)

5. The device of claim 2, wherein the at least one carbon membrane is macroporous has a pore size in the range of 60 nm and 2000 nm.

6. The device of claim 1, wherein the carbon-based material comprises at least one carbon membrane comprising mesopores and macropores.

7. The device of claim 6, wherein the at least one carbon membrane has a pore size in the range of 2 nm and 30 nm and in the range of 60 nm and 2000 nm.

8. The device of claim 1, wherein the carbon-based material comprises two or more monolithic porous carbon membranes.

9. The device of claim 8, wherein the carbon membranes have different porosity.

10. (canceled)

11. (canceled)

12. (canceled)

13. The device of claim 1, wherein the polymer is selected from the group consisting of a photoresist polymer, a biocompatible polymer, a biodegradable polymer, an extracellular matrix protein, and a combination thereof.

14. The device of 13, wherein the polymer is SU-8 photoresist.

15. The device claim 13, wherein the polymer is selected from the group consisting of polydimethylsiloxane, poly(methyl methacrylate), poly lactic-co-glycolic acid, poly(ethylene glycol) diacrylate, collagen, and gelatin.

16. The device of claim 1, wherein the flexible substrate has an open porosity of at least about 10%; or wherein the flexible substrate is non-porous.

17. The device of claim 1, wherein the one or more monolithic porous carbon membranes prepared by a process comprising:
contacting a carbon precursor with an organic template in a carrier solution to form a dispersion of micelles within the carrier solution;
providing the carrier solution with the dispersion of micelles to a silicon oxide substrate; and
removing the carrier solution and heating the substrate to obtain the monolithic porous carbon membrane.

18. A method for modulating activity of a cell, the method comprising:
contacting a membrane of the cell with a device according to claim 18 to form a structure-cell membrane interface; and
providing an electrochemical energy pulse to the interface under conditions to depolarize the cell membrane thereby increase a threshold for activation of the cell,
wherein the cell is capable of being activated by the energy pulse.

19. The method according to claim 18, wherein the cell is a cardiomyocyte, a neuron, or a retinal cell.

20. The method according to claim 18, wherein the cell is a cardiomyocyte.

21. The method according to claim 18, wherein the cell is a neuron.

22. The method according to claim 18, wherein the structure-cell interface is a direct interface between the device and the cell membrane, optionally wherein the contacting is without penetrating the cell membrane.

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. A process for preparing a device according to claim 1, the process comprising:
contacting a carbon precursor with an organic template in a carrier solution to form a dispersion of micelles within the carrier solution;
providing the carrier solution with the dispersion of micelles to a silicon oxide substrate; and
removing the carrier solution and heating the substrate to obtain a monolithic porous carbon membrane having a first planar surface and a second planar surface.

40. The process of claim 39, further comprising:
contacting the second planar surface of the monolithic porous carbon membrane with a first planar surface of a metal layer having a first planar surface and a second planar surface; and
optionally providing a flexible substrate to the second planar surface of the metal layer.
